(19) United States
(12) Patent Application Publication
(10) Pub. No.: US 2025/0258593 A1
(43) Pub. Date: Aug. 14, 2025

(54) AUTOMATICALLY ORGANIZING CONTENT COLLECTIONS WITH SMART CONTENT SYNTHESIS AND DYNAMIC FACETS

(71) Applicant: Dropbox, Inc., San Francisco, CA (US)

(72) Inventors: Sigalit Sadeh, Tel Aviv (IL); Vasanth Krishna Namasivayam, Dublin, CA (US); Morgan Zerby, Kirkland, WA (US); Sohrab Seyed Fathi, Saratoga, CA (US); Reut Valiano, Kfar Saba (IL); Devin Mancuso, San Francisco, CA (US); Yael Keren, Nordia (IL); Carola Pescio Canale, Alameda, CA (US)

(21) Appl. No.: 19/195,494

(22) Filed: Apr. 30, 2025

Related U.S. Application Data
(63) Continuation of application No. 17/931,821, filed on Sep. 13, 2022.
(60) Provisional application No. 63/365,550, filed on May 31, 2022.

(51) Int. Cl. G06F 3/04842; G06F 3/04817

(52) U.S. Cl. CPC G06F 3/04842; G06F 3/04817

(57) ABSTRACT

The present disclosure is directed toward systems, methods, and non-transitory computer readable media for generating, arranging, and providing subgroupings of content items according to content attributes and dynamic facets. For example, the disclosed systems generate dynamic facets reflecting content attributes, where the dynamic facets are selectable interface elements for arranging content items into subgroups. In certain cases, as part of generating a subgrouping of content items, the disclosed systems can identify portions of content items (e.g., segments of a digital video or sections of a digital document) that correspond to a dynamic facet. The disclosed systems can also provide filtering options for creating or refining subgroupings from a content collection by, for example, filtering according to recency criteria such as file type, recency of interaction, collaborative user accounts, or others.

### CROSS-REFERENCE TO RELATED APPLICATIONS

This application is a continuation of U.S. patent application Ser. No. 17/931,821, filed on Sep. 13, 2022, which claims the benefit of, and priority to, U.S. Provisional Application No. 63/365,550, filed on May 31, 2022. Each of the aforementioned applications is hereby incorporated by reference in its entirety.

### BACKGROUND

Advancements in computing devices and networking technology have given rise to a variety of innovations in cloud-based digital content storage and sharing. For example, online digital content systems can provide access to digital content items across devices all over the world. Existing systems can also synchronize changes to shared digital content across different types of devices operating on different platforms. Indeed, modem online digital content systems can provide access to digital content for users to collaborate across diverse physical locations and over a variety of computing devices. Despite these advances, however, existing digital content systems continue to suffer from a number of disadvantages, particularly in terms of flexibility, accuracy, and efficiency.

As just suggested, some existing digital content systems are inflexible. More specifically, certain existing systems rigidly adhere to a folder-based paradigm to organize content items. Indeed, the prevailing organizational structure of most existing systems is to use hierarchically arranged folders to store content items such as digital images, documents, and other file types. While such an organizational structure does afford some measure of consistency and familiarity, it also prevents systems from flexibly adapting digital content organization to fit user account preferences on an individual basis and/or as user account preferences change over time (or even between sessions). Consequently, many existing systems that adopt the folder-based hierarchy are incapable of adapting to other ways of organizing content items that may be better suited for modern applications and use cases, particularly in digital content creation.

As further suggested, existing digital content systems are sometimes inaccurate. In particular, because many existing systems are tied to folder-based organization, such systems often generate many duplicates of content items when using various applications to modify or organize the content items. For example, existing systems often use a content modification application or a content organization application as a layer for engaging with content items stored within folders. However, using these application layers to modify and organize digital content often requires generating duplicates of content items (rather than manipulating an original version of a content item) which can become disorganized (and which wastes storage resources). As a result, there is often no single source of truth for content items within existing systems, which leads to ambiguity and inaccuracy.

Due at least in part to their inaccuracy, many existing digital content systems are inefficient. To elaborate, as a result of not having a single source of truth for managing and modifying digital content, existing folder hierarchy systems sometimes waste computer memory and storage resources by generating excessive content item duplicates. In addition, the folder-based organizational paradigm of many existing systems results in inefficient user interfaces that require onerous numbers of user interactions to access and/or organize content items. Indeed, researchers have demonstrated that, in existing folder-based systems, the number of interactions (and the corresponding time) to retrieve digital content is substantial only growing as more of life moves online and the volume of digital content stored in cloud-based content management systems increases. Mitigating at least some of the burden of accessing content items often requires organization on the part of individual user accounts to place content items into respective folders, but even these organizational steps take a substantial number of user interactions (and a long time). Processing the excessive numbers of user interactions involved in existing systems (e.g., in accessing and/or organizing content items) consumes computing resources such as processing power and memory that could otherwise be preserved with more efficient systems and/or user interfaces.

Thus, there are several disadvantages with regard to existing digital content systems.

### SUMMARY

This disclosure describes one or more embodiments of systems, methods, and non-transitory computer readable storage media that provide benefits and/or solve one or more of the foregoing and other problems in the art. For instance, the disclosed systems provide a new method for generating, arranging, and providing content collections for user accounts. In some embodiments, the disclosed systems generate a subgrouping from a content collection by using dynamic facets corresponding to content attributes associated with content items of the content collection. For example, the disclosed systems generate dynamic facets reflecting content attributes, where the dynamic facets are selectable interface elements for arranging content items into subgroups. In certain cases, as part of generating a subgrouping of content items, the disclosed systems can identify portions of content items (e.g., segments of a digital video or sections of a digital document) that correspond to a dynamic facet. The disclosed systems can also provide filtering options for creating or refining subgroupings from a content collection by, for example, filtering according to recency criteria such as file type, recency of interaction, collaborative user accounts, or others.

Additional features of the disclosed systems are described below.

### BRIEF DESCRIPTION OF THE DRAWINGS

This disclosure will describe one or more example implementations of the systems and methods with additional specificity and detail by referencing the accompanying figures. The following paragraphs briefly describe those figures, in which:

FIG. 1 illustrates a schematic diagram of an example environment of a smart organization system in accordance with one or more embodiments;

FIG. 2 illustrates an example overview of generating and providing subgrouping of content items in accordance with one or more embodiments;

FIG. 3 illustrates an example smart organization interface in accordance with one or more embodiments;

FIG. 4 illustrates an example smart organization interface for presenting a subgrouping corresponding to a dynamic facet in accordance with one or more embodiments;

FIG. 5 illustrates an example smart organization interface for selecting one or more filtering criteria in accordance with one or more embodiments;

FIG. 6 illustrates an example smart organization interface for presenting a subgrouping corresponding to a dynamic facet and one or more filtering criteria in accordance with one or more embodiments;

FIG. 7 illustrates an example smart organization interface for presenting a subgrouping corresponding to multiple dynamic facets in accordance with one or more embodiments;

FIG. 8 illustrates an example smart organization interface for selecting collaborator filtering criteria in accordance with one or more embodiments;

FIG. 9 illustrates an example smart organization interface in accordance with one or more embodiments;

FIG. 10 illustrates an example smart organization interface for presenting a subgrouping corresponding to a dynamic facet and a filtering category in accordance with one or more embodiments;

FIG. 11 illustrates an example content breakdown interface for a set of content items in accordance with one or more embodiments;

FIG. 12 illustrates an example smart organization interface for digital images in accordance with one or more embodiments;

FIG. 13 illustrates an example content breakdown interface for digital images in accordance with one or more embodiments;

FIG. 14 illustrates an example digital video portion interface in accordance with one or more embodiments;

FIG. 15 illustrates an example document portion interface in accordance with one or more embodiments;

FIG. 16 illustrates an example diagram for generating dynamic facets from content attributes in accordance with one or more embodiments;

FIG. 17 illustrates an example diagram for generating a subgrouping of content items in accordance with one or more embodiments;

FIG. 18 illustrates an example diagram for training a machine learning model in accordance with one or more embodiments;

FIG. 19 illustrates a flowchart of a series of acts for generating and providing a subgrouping based on dynamic facets in accordance with one or more embodiments;

FIG. 20 illustrates a block diagram of an exemplary computing device in accordance with one or more embodiments; and

FIG. 21 illustrates an example environment of a networking system having the smart organization system in accordance with one or more embodiments.

### DETAILED DESCRIPTION

This disclosure describes one or more embodiments of a smart organization system that can utilize advanced content synthesis to automatically and intelligently organize content items of a content collection. In particular, the smart organization system can arrange or organize content items from a content collection (e.g., within a cloud-based content management system) according to dynamic facets and/or filtering criteria. For example, the smart organization system can generate and utilize dynamic facets for organizing content items into subgroupings based on content attributes. Specifically, the smart organization system can generate dynamic facets utilizing machine learning techniques to predict topics (or other content attributes) associated with content items of a content collection and generate dynamic facets to reflect the content attributes (and for user selection to organize the content items). In addition, the smart organization system can utilize filter options for creating or refining subgroupings of content collections by organizing content items according to certain filtering categories.

As just mentioned, the smart organization system can generate dynamic facets for organizing content items. More particularly, the smart organization system can determine content attributes associated with content items of a content collection (e.g., a content collection associated with a user account of a content management system). The content attributes can reflect key phrases, depicted objects, topics, themes, or other attributes associated with content items. In some cases, the smart organization system utilizes one or more machine learning models to determine or predict content attributes from content items. In these or other cases, the smart organization system further utilizes a dynamic facet generator model (e.g., a dynamic facet machine learning model) to generate dynamic facets from the content attributes.

As also mentioned, the smart organization system can utilize dynamic facets to group, arrange, or organize content items into subgroupings (e.g., subgroupings of a content collection). Specifically, the smart organization system can receive an indication of user interaction selecting a dynamic facet from a smart organization interface and can generate a subgrouping of content items corresponding to the dynamic facet (or corresponding to the content attribute of the dynamic facet). As part of generating a content subgrouping, in some embodiments, the smart organization system identifies and provides portions of content items (as opposed to complete or entire content items). To elaborate, the smart organization system identifies segments, portions, sections, or parts of content items that correspond to a selected dynamic facet, and the smart organization system provides the identified portions as part of a subgrouping (e.g., excluding other portions not related to the dynamic facet). The smart organization system can further generate a new content collection from a subgrouping (e.g., automatically without user input instigating the generation of the subgrouping or in response to user interaction selecting a collection creation option).

In one or more embodiments, the smart organization system can not only utilize dynamic facets for generating subgroupings but can also (or alternatively) utilize filtering options. For instance, the smart organization system can provide selectable filter options to filter content items according to filtering categories such as theme, file type, recency, and collaborative co-user accounts. Based on user interaction selecting one or more filtering criteria from a filtering category, the smart organization system can refine or modify a subgrouping to include content items that satisfy the filtering criteria (and exclude content items that do not).

In a similar fashion, the smart organization system can update, refine, or modify a subgrouping based on user selection of additional dynamic facets. For instance, based on generating a subgrouping in response to user selection of a first dynamic facet, the smart organization system can generate an updated set of dynamic facets to display for user selection and that reflect content attributes of the subgrouping. In addition, the smart organization system can receive a user selection of a second dynamic facet from the updated set, and the smart organization system can generate a modified subgrouping by identifying content items that correspond to the content attributes of both the first dynamic facet and the second dynamic facet (and excluding other content items).

As suggested above, the smart organization system can provide several improvements or advantages over existing digital content systems. For example, some embodiments of the smart organization system can improve flexibility over prior systems. As opposed to existing systems that rigidly adhere to hierarchical folder structures, the smart organization system can organize content collections into subgroupings according to content attributes, based on dynamic facets and/or filtering criteria. As a result, the smart organization system can provide more flexible, modifiable content organization tailored for specific use cases (such as content generation), topics, or other domains. Indeed, the smart organization system can adapt the organization of content collections for individual user accounts according to changing user preferences, rather than perpetually maintaining the same rigid folder structure across all user accounts.

In addition to improving flexibility over prior digital content systems, the smart organization system can also improve accuracy. To elaborate, rather than creating ambiguity through generating duplicate content items through modifying or organizing content items using different applications, the smart organization system can maintain a single source of truth for a content item. Indeed, the smart organization system can utilize a content collection for a user account as a source of truth for content items within the content collection. Upon generating a subgrouping, the smart organization system can include (within the subgrouping) links, pointers, or references to the content items of the subgrouping that indicate (network locations of) corresponding content items within the content collection (without necessarily creating duplicate copies of the content items).

Due at least in part to improving accuracy over prior digital content systems, the smart organization system can also improve efficiency over such systems. For example, by mitigating or reducing the ambiguity of duplicate content items, the smart organization system can save storage resources that prior systems waste maintaining duplicative content. As another example, the smart organization system can provide more efficient user interfaces (e.g., a smart organization interface) that reduces the number of user interactions required to access desired data or functionality. Specifically, the smart organization system provides a smart organization interface that includes dynamic facets that reduce the number of user interactions for locating, accessing, and manipulating content items. Compared to prior systems that require user interaction to drill down through nested folders in a hierarchy and/or that require many user interactions to organize content items into respective folders, the smart organization system provides dynamic facets that, upon selection, cause the smart organization system to intelligently surface corresponding content items from a single source of truth (e.g., the content collection). Consequently, the smart organization system further saves computing resources that prior systems expend processing their larger numbers of user interactions for accessing or organizing content items.

As illustrated by the foregoing discussion, the present disclosure utilizes a variety of terms to describe features and benefits of the smart organization system. Additional detail is hereafter provided regarding the meaning of these terms as used in this disclosure. As used herein, the term “digital content item” (or simply “content item”) refers to a digital object or a digital file that includes information interpretable by a computing device (e.g., a client device) to present information to a user. A digital content item can include a file such as a digital text file, a digital image file, a digital audio file, a webpage, a website, a digital video file, a web file, a link, a digital document file, or some other type of file or digital object. A digital content item can have a particular file type or file format, which may differ for different types of digital content items (e.g., digital documents, digital images, digital videos, or digital audio files). In some cases, a digital content item can refer to a remotely stored (e.g., cloud-based) item or a link (e.g., a link to a cloud-based item or a web-based content item) and/or a content clip that indicates (or links) a discrete selection or segmented portion of content from a webpage or some other content item or source. A digital content item can be editable or otherwise modifiable and can also be sharable from one user account (or client device) to another. In some cases, a digital content item is modifiable by multiple user accounts (or client devices) simultaneously and/or at different times.

Relatedly, the term “content collection” refers to a collection or grouping of content items. For example, a content collection includes content items stored in a common location on a device or a common cloud-based network location, such as a file or folder. In some cases, a content collection includes content items arranged together or otherwise associated with one another while stored in different locations. For instance, a content collection can refer to a grouping of content items associated with a user account of a content management system. In some embodiments, a content collection can include additional content collections therein, each containing different content items.

To generate a synthetic visualization, as mentioned, the smart organization system can generate and utilize content features for a content collection. As used herein, the term “content attribute” refers to a representation of an attribute, a feature, or a characteristic extracted from, or determined for, a content item or a content collection. For example, a content attribute can refer to an indication or a (numerical or mathematical) representation of an attribute associated with a content item. In some embodiments, a content attribute refers to a descriptive attribute that represents characteristics describing a content item. Descriptive attributes can include or indicate visual or non-visual attributes such as colors, objects, people, file types, text characters, layouts, topics, themes, key phrases, creator accounts, geotags, timestamps, and/or collaborative co-user accounts depicted in otherwise associated with a content item. In one or more embodiments, a content attribute refers to a relevance attribute that indicates a measure of relevance of the at least one content item to a user account within a content management system. For example, relevance attributes can include or indicate measures of relevance with respect to a user account within a content management system based on historical interactions of the user account (or co-user accounts) with content items.

As mentioned, the smart organization system can generate and utilize dynamic facets for organizing content items. As used herein, the term “dynamic facet” refers to a user interface element selectable to organize content items into subgroupings. In particular, a dynamic facet can represent or reflect one or more content attributes and can be selectable to generate a content subgrouping that includes content items corresponding to the one or more content attributes. In some cases, a dynamic facet refers to a machine-learning-generated element that corresponds to content items within a content collection or a subgrouping of a content collection.

As mentioned above, the smart organization system can generate dynamic facets using one or more machine learning models. As used herein, the term “machine learning model” refers to a computer algorithm or a collection of computer algorithms that automatically improve for a particular task through iterative outputs or predictions based on use of data. For example, a machine learning model can utilize one or more learning techniques to improve in accuracy and/or effectiveness. Example machine learning models include various types of neural networks, decision trees, support vector machines, linear regression models, and Bayesian networks. As described in further detail below, the smart organization system utilizes a “content attribute machine learning model” such as a neural network to generate or predict content attributes from content items of a content collection or a subgrouping. In addition, the smart organization system utilizes a “dynamic facet machine learning model” such as a neural network to generate or predict dynamic facets from content attributes associated with a content collection or a subgrouping.

Relatedly, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., generated recommendation scores) based on a plurality of inputs provided to the neural network. In some cases, a neural network refers to an algorithm (or set of algorithms) that implements deep learning techniques to model high-level abstractions in data. A neural network can include various layers such as an input layer, one or more hidden layers, and an output layer that each perform tasks for processing data. For example, a neural network can include a deep neural network, a convolutional neural network, a recurrent neural network (e.g., an LSTM), a graph neural network, or a generative adversarial neural network. Upon training as described below, such a neural network may become a content attribute neural network or a dynamic facet neural network.

As mentioned, in some embodiments, the smart organization system can generate or update subgroupings according to filter options. As used herein, a “filter option” can refer to a selectable user interface element for filtering content items (e.g., within a content collection or a subgrouping) based on a corresponding filtering category. A filtering category can refer to a genre or a domain of content filtering, such as “theme,” “file type,” “recency,” or “collaborators.” In some cases, a filtering category can be based on content attributes (to organize content items in conjunction with dynamic facets) and can include a collection of filtering criteria that make up the category. For example, the filtering category of “file type” can include filtering criteria corresponding to individual file types, such as “documents,” “images,” “videos,” “presentations,” or “audio.”

As used herein, the term “application session” (or sometimes simply “session”) refers to an instance of use within a client application or within a particular collection or folder or content item using a client application. For example, an application session refers a set of activities performed within a single login of a client application or an application of a content management system. As another example, an application session refers to a set of activities performed within a single visit of an application or a single access of a content collection or folder. In some cases, a session requires a login while in other cases, a session does not require a login and instead indicates an instance of use between closures or terminations (of an application or webpage) or between visits that are at least a threshold period of time apart (or separated by a device power off or sleep mode).

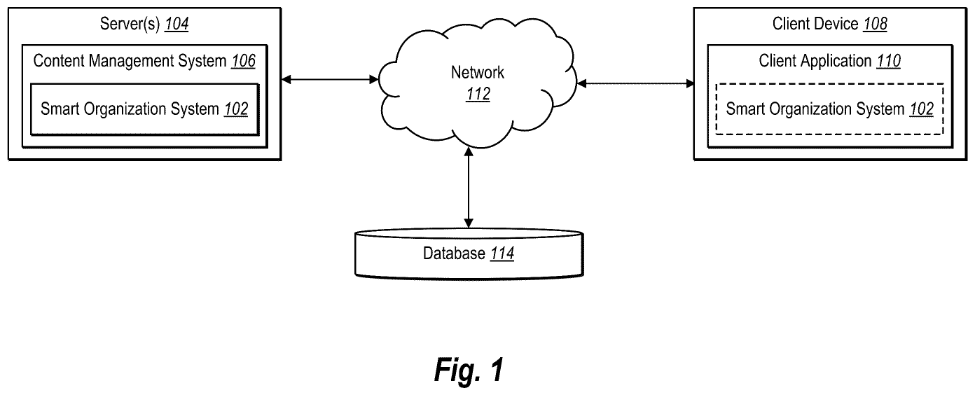

Additional detail regarding the smart organization system will now be provided with reference to the figures. For example, FIG. 1 illustrates a schematic diagram of an example system environment for implementing a smart organization system 102 in accordance with one or more implementations. An overview of the smart organization system 102 is described in relation to FIG. 1. Thereafter, a more detailed description of the components and processes of the smart organization system 102 is provided in relation to the subsequent figures.

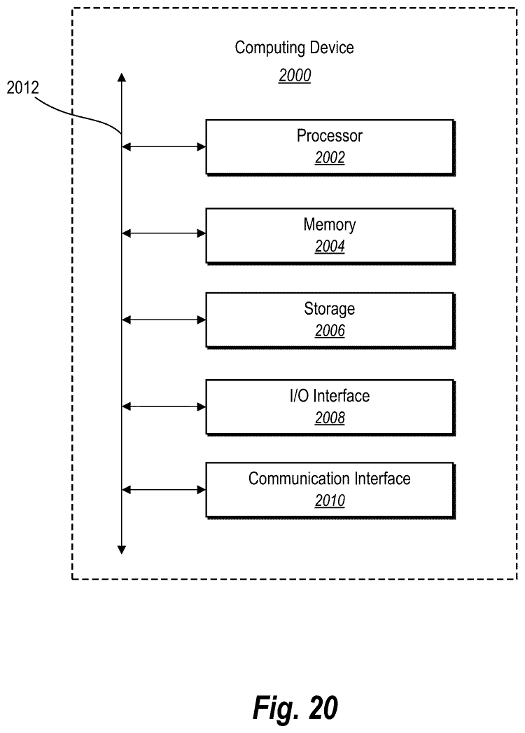

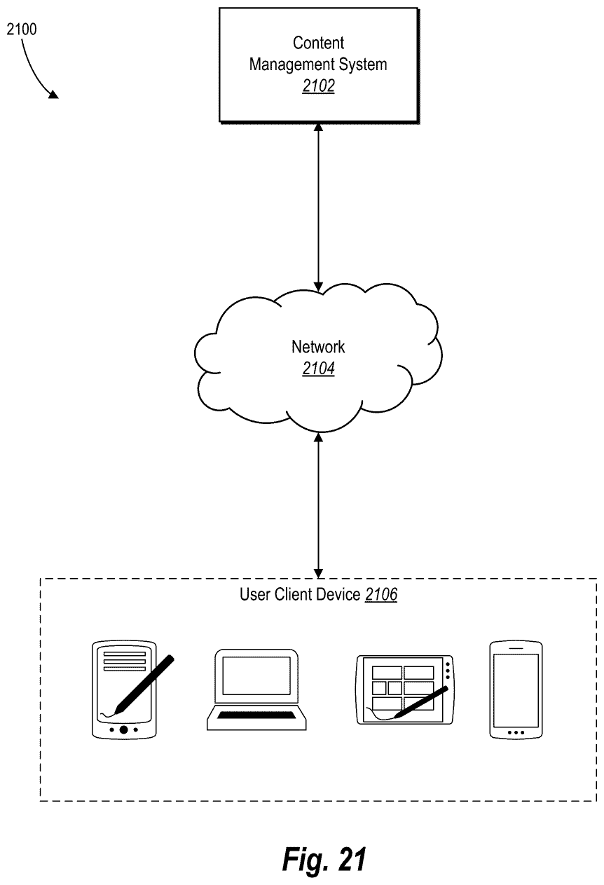

As shown, the environment includes server(s) 104, a client device 108, a database 114, and a network 112. Each of the components of the environment can communicate via the network 112, and the network 112 may be any suitable network over which computing devices can communicate. Example networks are discussed in more detail below in relation to FIGS. 20-21.

As mentioned above, the example environment includes a client device 108. The client device 108 can be one of a variety of computing devices, including a smartphone, a tablet, a smart television, a desktop computer, a laptop computer, a virtual reality device, an augmented reality device, or another computing device as described in relation to FIGS. 20-21. The client device 108 can communicate with the server(s) 104 and/or the database 114 via the network 112. For example, the client device 108 can receive user input from respective users interacting with the client device 108 (e.g., via the client application 110) to, for instance, access, generate, modify, or share a content item, to collaborate with a co-user of a different client device, or to select a user interface element such as dynamic facet or a filter option. In addition, the smart organization system 102 on the server(s) 104 can receive information relating to various interactions with content items and/or user interface elements based on the input received by the client device 108 (e.g., to access content items, generate subgroupings of content items, or perform some other action).

As shown, the client device 108 can include a client application 110. In particular, the client application 110 may be a web application, a native application installed on the client device 108 (e.g., a mobile application, a desktop application, etc.), or a cloud-based application where all or part of the functionality is performed by the server(s) 104. Based on instructions from the client application 110, the client device 108 can present or display information, including a user interface such as a smart organization interface that includes depictions of content items in a collection or a subgrouping, along with filter options and dynamic facets.

As illustrated in FIG. 1, the example environment also includes the server(s) 104. The server(s) 104 may generate, track, store, process, receive, and transmit electronic data, such as digital content items, dynamic facets, interactions with digital content items, and/or interactions between user accounts or client devices. For example, the server(s) 104 may receive data from the client device 108 in the form of a request to generate a content item or to generate a subgrouping for a dynamic facet. In addition, the server(s) 104 can transmit data to the client device 108 in the form of a content item, a comment, content attributes, a dynamic facet, or some other information. Indeed, the server(s) 104 can communicate with the client device 108 to send and/or receive data via the network 112. In some implementations, the server(s) 104 comprise(s) a distributed server where the server(s) 104 include(s) a number of server devices distributed across the network 112 and located in different physical locations. The server(s) 104 can comprise one or more content servers, application servers, communication servers, web-hosting servers, machine learning server, and other types of servers.

As shown in FIG. 1, the server(s) 104 can also include the smart organization system 102 as part of a content management system 106. The content management system 106 can communicate with the client device 108 to perform various functions associated with the client application 110 such as managing user accounts, managing content collections, managing content items, and facilitating user interaction with the content collections and/or content items. Indeed, the content management system 106 can include a network-based smart cloud storage system to manage, store, and maintain content items and related data across numerous user accounts. In some embodiments, the smart organization system 102 and/or the content management system 106 utilize the database 114 to store and access information such as digital content items, content attributes, dynamic facets, and other information.

Although FIG. 1 depicts the smart organization system 102 located on the server(s) 104, in some implementations, the smart organization system 102 may be implemented by (e.g., located entirely or in part) on one or more other components of the environment. For example, the smart organization system 102 may be implemented by the client device 108, and/or a third-party device. For example, the client device 108 can download all or part of the smart organization system 102 for implementation independent of, or together with, the server(s) 104.

In some implementations, though not illustrated in FIG. 1, the environment may have a different arrangement of components and/or may have a different number or set of components altogether. For example, the client device 108 may communicate directly with the smart organization system 102, bypassing the network 112. As another example, the environment may include multiple client devices, each associated with a different user account for managing digital content items. In addition, the environment can include the database 114 located external to the server(s) 104 (e.g., in communication via the network 112) or located on the server(s) 104 and/or on the client device 108.

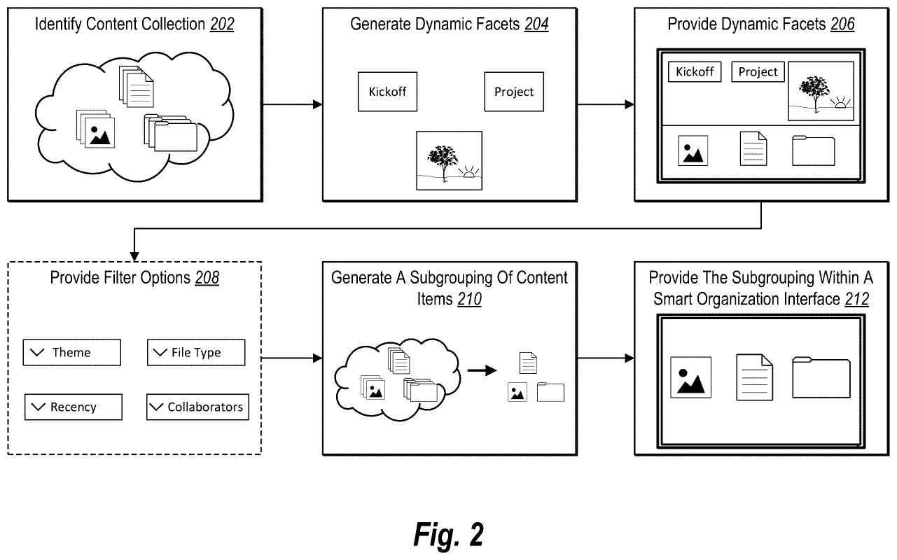

As mentioned above, the smart organization system 102 can intelligently organize content items utilizing smart organizational tools called dynamic facets. In particular, the smart organization system 102 can generate dynamic facets from content items and can utilize the dynamic facets to further organize or arrange the content items into subgroupings. FIG. 2 illustrates an overview of generating and utilizing dynamic facets to generate subgroupings of content items in accordance with one or more embodiments. Additional detail regarding the various acts of FIG. 2 is provided thereafter with reference to subsequent figures.

As illustrated in FIG. 2, the smart organization system 102 performs an act 202 to identify a content collection. More specifically, the smart organization system 102 identifies a content collection associated with a user account of the content management system 106. For example, the smart organization system 102 identifies or determines content items within a content collection. The content collection can include digital images, digital documents, and/or content items of other file types. The content collection can also include one or more collaborative content items accessible by collaborative co-user accounts of the smart organization system 102. In some embodiments, the smart organization system 102 identifies a content collection that includes content items stored in one or more network locations associated with the content management system 106 (and tied to a common user account).

As further illustrated in FIG. 2, the smart organization system 102 performs an act 204 to generate dynamic facets. In particular, the smart organization system 102 generates one or more dynamic facets based on content attributes of content items within a content collection (as identified via the act 202). For example, the smart organization system 102 determines content attributes such as descriptive attributes indicating colors, objects, key phrases, topics, or other visual or non-visual attributes of the content items. As another example, the smart organization system 102 determines relevance attributes such as interactions by a user account with content items of the collection, including shares, modifications, comments, and accesses. In some cases, the smart organization system 102 utilizes one or more content attribute machine learning models to generate or determine content attributes for content items within the content collection. Additional detail regarding determining content attributes is provided below with reference to subsequent figures.

Based on determining content attributes, the smart organization system 102 further generates dynamic facets corresponding to a content collection. To elaborate, the smart organization system 102 determines a measure of prominence or prevalence for content attributes within a content collection. For instance, the smart organization system 102 determines a measure of prominence or prevalence by identifying content attributes that are more or less common within a content collection. Indeed, the smart organization system 102 determines content attributes that are shared by multiple content items within the content collection. In some cases, to generate a dynamic facet, the smart organization system 102 determines content attributes shared by at least a threshold number of content items.

Additionally, the smart organization system 102 can determine relevance of content attributes in relation to a user account (e.g., based on historical activity of the user account). Based on relevance and/or prominence (or other factors) of content attributes, the smart organization system 102 can generate a dynamic facet as an interface element that reflects or represents one or more content attributes associated with a content collection. In these or other cases, the smart organization system 102 utilizes a dynamic facet machine learning model to generate dynamic facets from content attributes. Additional detail regarding generating dynamic facets is provided below with reference to subsequent figures.

Additionally, the smart organization system 102 performs an act 206 to provide the dynamic facets. In particular, the smart organization system 102 provides the dynamic facets for display within a user interface (e.g., a smart organization interface) on the client device 108. In some embodiments, the smart organization system 102 selects a set of dynamic facets that satisfy a threshold relevance in relation to a user account. In these or other embodiments, the smart organization system 102 selects dynamic facets that satisfy a threshold measure of prominence (or whose content attributes satisfy a threshold measure of prominence). In certain cases, the smart organization system 102 also (or alternatively) ranks dynamic facets according to relevance and/or prominence using a rule-based heuristic. As shown, the smart organization system 102 can generate dynamic facets that reflect words or phrases and/or that reflect images or objects selectable to view a subgrouping of content items depicting similar images or objects. The smart organization system 102 further provides selected (and/or ranked) dynamic facets for display within a smart organization interface (e.g., with higher ranked dynamic facets appearing first in a list of facets).

As further illustrated in FIG. 2, in some embodiments, the smart organization system 102 performs an act 208 to provide filter options. More particularly, the smart organization system 102 generates and provides filter options to generate, update, or modify a content collection or a subgrouping of content items. For example, the smart organization system 102 provides filter options as selectable interface elements to filter content items according to respective filtering categories, including a theme filter option for filtering content items according to various themes, a file type filter option for filtering content items according to file type, a recency filter option for filtering content items according to recency of user account activity with respect to the plurality of content items, and a collaborators filter option for filtering content items according to collaborative co-user accounts within the content management system. Within a filtering category, the smart organization system 102 can further provide more granular filtering criteria whereby a user account can select specific file types, particular collaborative co-user accounts, or other details within a certain category by which to filter.

As further shown, the smart organization system 102 performs an act 210 to generate a subgrouping of content items. In particular, the smart organization system 102 generates a subgrouping based on one or more dynamic facets and/or filter options. For example, the smart organization system 102 generates a subgrouping of content items by selecting, from a content collection, content items that correspond to content attributes of a dynamic facet selected via user interaction. In some cases, the smart organization system 102 generates a subgrouping based on user selection of multiple dynamic facets. The smart organization system 102 can also refine or update a subgrouping based on filter options and/or additional dynamic facets (e.g., by excluding content items that do not satisfy filtering criteria and/or that do not corresponding to a selected dynamic facet). Based on generating a subgrouping, the smart organization system 102 can further generate an updated set of dynamic facets corresponding to the subgrouping (e.g., by repeating the act 204 for the subgrouping).

As further illustrated in FIG. 2, the smart organization system 102 performs an act 212 to provide the subgrouping within a smart organization interface. Specifically, the smart organization system 102 provides a subgrouping of content items for display within a smart organization interface on the client device 108. In certain cases, the smart organization system 102 further generates the smart organization interface to include interface elements such as filter options and dynamic facets. In some embodiments, the smart organization system 102 also provides a collection creation option for display within a smart organization interface. Based on a user interaction selecting the collection creation option, the smart organization system 102 generates a new content collection (associated with the user account) for the subgrouping presented within the smart organization interface.

Using the described subgrouping techniques, the smart organization system 102 can facilitate multiple collaborative co-user accounts (or multiple client devices) interacting with the same subgroupings simultaneously or contemporaneously. For example, the smart organization system 102 can provide a smart organization interface on a first client device and a second client device, where each device can provide inputs for generating and modifying a subgrouping based on dynamic facets and filter options (e.g., using the smart organization interfaces described below). In a similar vein, the smart organization system 102 can also facilitate sharing subgroupings with other co-user accounts of the content management system 106 (or even outside of the content management system 106).

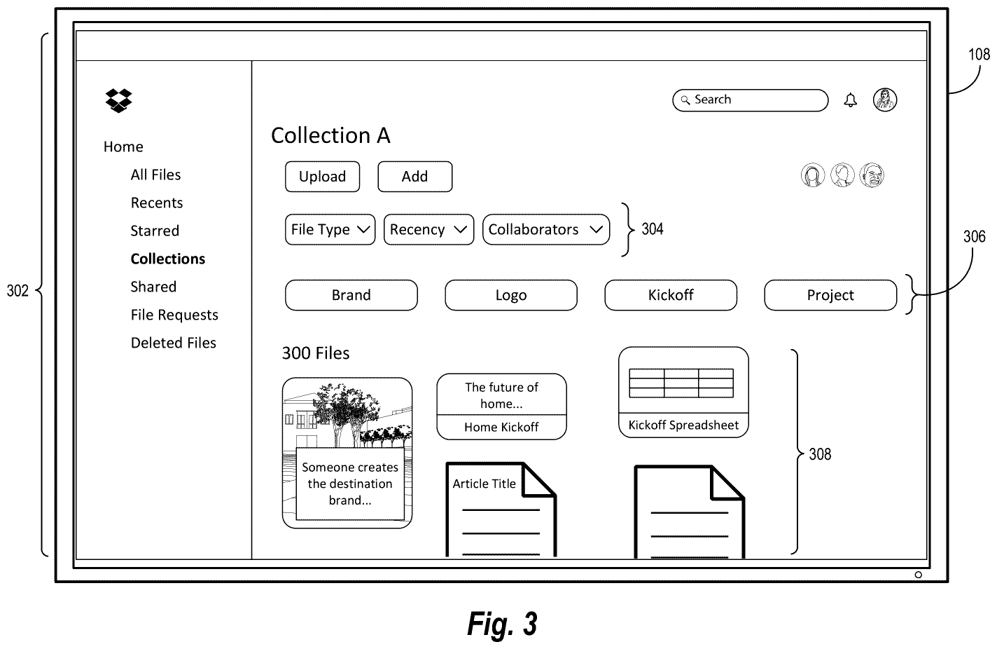

As mentioned above, in certain described embodiments, the smart organization system 102 generates and provides a smart organization interface for display on a client device (e.g., the client device 108). In particular, the smart organization system 102 provides a smart organization interface for presenting subgroupings of content items from a content collection. FIG. 3 illustrates an example smart organization interface including dynamic facets and filter options in accordance with one or more embodiments. Thereafter, subsequent figures illustrate how the smart organization system 102 updates or modifies a smart organization interface based on various user interactions. In some cases, the smart organization system 102 performs new rankings, generates new subgroupings, updates dynamic facets, and performs other functions described below in real time (or near real time) with user interactions selecting various interface elements to prompt the functions.

As illustrated in FIG. 3, the client device 108 displays a smart organization interface 302 that includes interactive interface elements for managing content items within a content collection (“Collection A”) associated with a user account within the content management system 106. As shown, the smart organization interface 302 includes filter options 304, dynamic facets 306, and content items 308. In particular, the smart organization system 102 provides the content items 308 (or content cards that visually represent or depict content items) from Collection A for display within the smart organization interface 302. In addition, the smart organization system 102 provides a set of filter options 304 that correspond to respective filtering categories (e.g., file type, recency, and collaborators), where each of the filter options 304 is selectable and expandable select filtering criteria (as described below).

Further, the smart organization system 102 provides, within the smart organization interface 302, a set of dynamic facets 306 corresponding to the content items 308 of Collection A. For example, the smart organization system 102 analyzes the content items 308 to determine content attributes. From the content attributes of the content items 308, the smart organization system 102 further generates the dynamic facets 306. Specifically, the smart organization system 102 generates the dynamic facets 306 to represent content attributes using key phrases, images, or other visual representations of content attributes. As shown, the dynamic facets 306 represent or reflect (using key phrases) content attributes such as topics or themes found among the content items 308 of with Collection A, such as “Brand,” “Logo,” “Kickoff,” and “Project.”

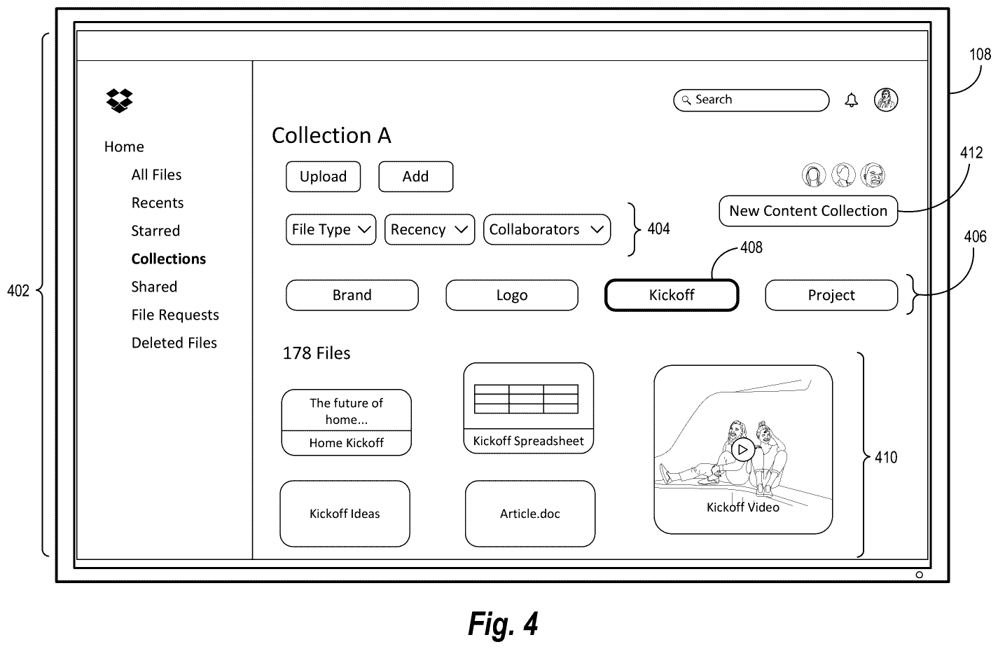

As mentioned, the smart organization system 102 can modify a smart organization interface based on user interaction selecting a dynamic facet. In particular, the smart organization system 102 can generate a subgrouping of content items from a content collection to present in response to user interaction selecting a dynamic facet from within a smart organization interface. FIG. 4 illustrates a smart organization interface depicting a subgrouping for a dynamic facet in accordance with one or more embodiments.

As illustrated in FIG. 4, the client device 108 displays a smart organization interface 402 that includes or depicts a subgrouping 410 of content items based on user selection of a dynamic facet, together with a set of filter options 404 and dynamic facets 406. In particular, the smart organization system 102 receives a user interaction selecting a dynamic facet 408 (“Kickoff”) from among a set of dynamic facets 406. In response to the selection, the smart organization system 102 generates or arranges a subgrouping 410 by identifying content items (from Collection A) that correspond to the content attribute of the dynamic facet 408. Specifically, the smart organization system 102 selects, from Collection A, content items that correspond to (e.g., include, depict, represent, or reflect) the key phrase “Kickoff” Indeed, as shown, the smart organization system 102 generates the subgrouping 410 that includes 178 files from among the total number of 300 files within Collection A (as illustrated in FIG. 3).

As further illustrated in FIG. 4, the smart organization system 102 provides a collection creation option 412 for display within the smart organization interface 402. Indeed, based on generating the subgrouping 410, the smart organization system 102 populates the smart organization interface 402 to include the collection creation option 412. Based on user interaction selecting the collection creation option 412, the smart organization system 102 generates a new content collection within the content management system 106 for the user account. Specifically, the smart organization system 102 generates a new content collection from Collection A to include only those content items referenced or indicated within the subgrouping 410.

In some cases, the subgrouping 410 is temporary and not necessarily stored in a database (e.g., the database 114) or within the content management system 106. Indeed, the smart organization system 102 treats the subgrouping 410 as ephemeral and only available within the smart organization interface 402. Upon selection of the collection creation option 412, however, the smart organization system 102 stores the subgrouping 410 to assign the subgrouping 410 to the user account within the content management system 106. For instance, the smart organization system 102 assigns memory within the content management system 106 (e.g., within a network database) to store copies of, or links to, content items included within the subgrouping 410. The smart organization system 102 further makes the new content collection for the subgrouping 410 available for access via various content management interfaces and across client devices of the user account.

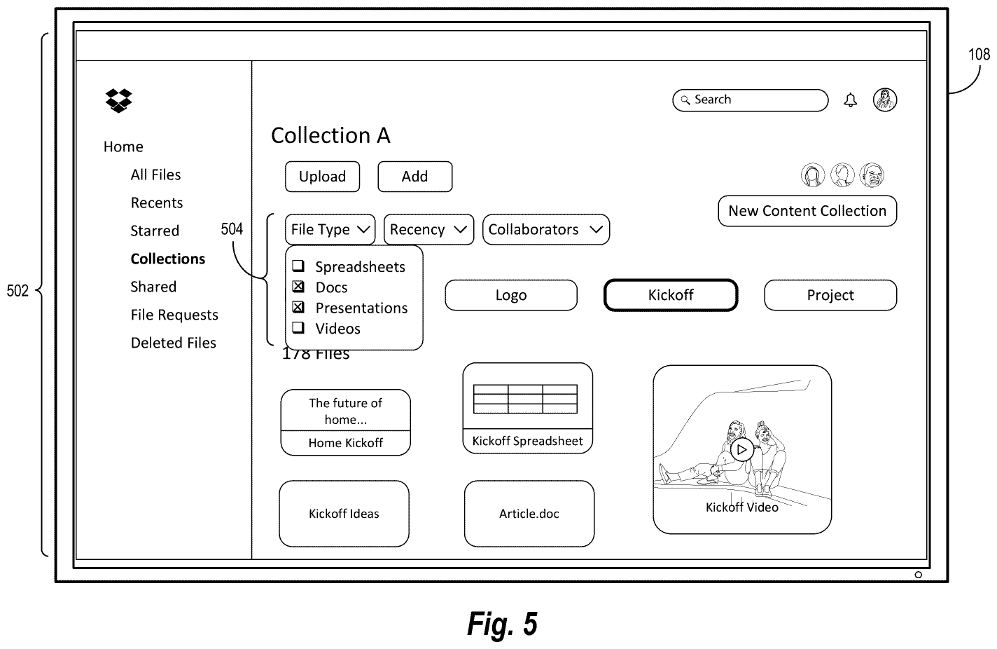

In certain embodiments, the smart organization system 102 further refines, modifies, or updates a subgrouping (or generates a new subgrouping) based on filter options. In particular, the smart organization system 102 identifies one or more filtering criteria based on user selection and further filters out content items that do not satisfy the filtering criteria. FIG. 5 illustrates a smart organization interface for selecting filtering criteria of a filter option to modify a subgrouping (or generate a new subgrouping) in accordance with one or more embodiments.

As illustrated in FIG. 5, the client device 108 displays a smart organization interface 502 that includes a filter options 504. Indeed, based on a user selection the smart organization system 102 expands the filter option 504 to present filtering criteria within the filtering category (file type) of the filter option 504. As shown, the filtering criteria for the file type category include spreadsheets, documents, presentations, and videos. In some cases, the filter option 504 is scrollable to view more filtering criteria for other file types. As further shown, the smart organization system 102 receives user interactions selecting documents and presentations as filtering criteria for filtering content items of a subgrouping (e.g., the subgrouping 410).

The smart organization system 102 can further filter content items based on other filter options as well. For instance, the smart organization system 102 can expand a filter option for the recency option to filter by various recency criteria. Specifically, the smart organization system 102 can filter content items by including only content items with which the user account has interacted within a threshold recency (e.g., the past hour, day, or week). In these or other embodiments, the smart organization system 102 can filter according to recency relative to filtering criteria indicating specific user account activity, such as filtering according to recent selections, recent shares, recent comments, recent modifications, or other recent activity.

Further, the smart organization system 102 can filter according to the collaborators filter option. For example, the smart organization system 102 can expand the collaborators filter option to present collaborators filtering criteria. In some cases, the collaborators filtering criteria can include user account identifiers for collaborative co-user accounts (within the content management system 106). Thus, based on user selection of one or more collaborative co-user accounts, the smart organization system 102 filters content items from a subgrouping (e.g., the subgrouping 410) to modify the subgrouping or to generate a new subgrouping.

Additionally, the smart organization system 102 can utilize other filtering options as well (or in the alternative). For example, the smart organization system 102 can filter content items according to a theme filter option. To elaborate, the smart organization system 102 can provide a theme filter option for display within the smart organization interface 502. In response to user selection of the theme filter option, the smart organization system 102 expands the filter option to present theme filtering criteria. For instance, the theme filtering criteria can include themes such as “work,” “personal,” “shared,” “school,” or other themes associated with content items. Based on selection of one or more theme filtering criteria, the smart organization system 102 modifies a subgrouping by removing content items that do not satisfy the criteria.

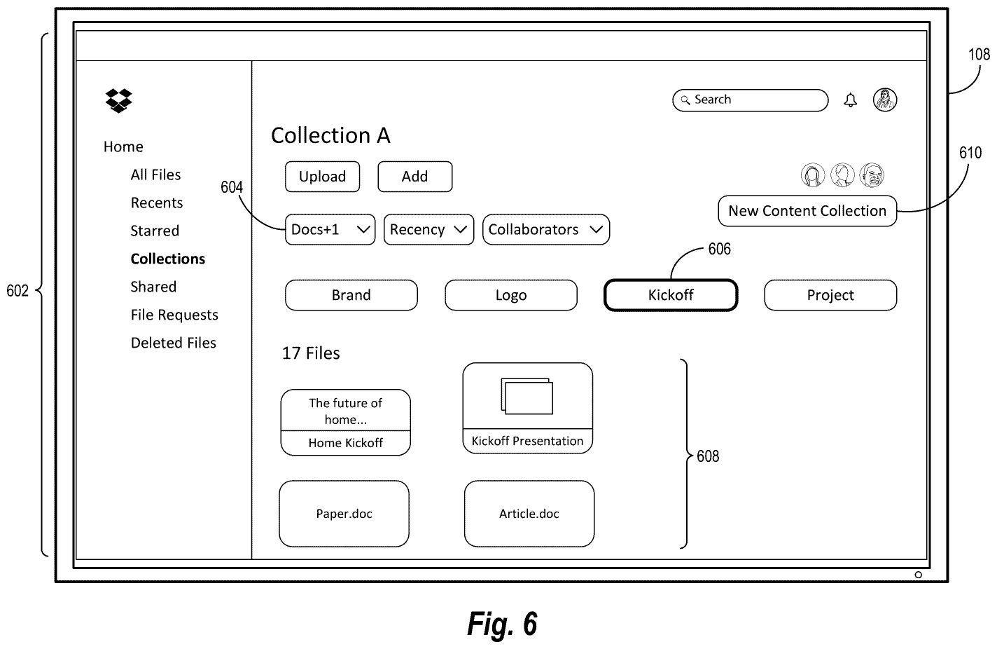

As mentioned above, in certain embodiments, the smart organization system 102 generates a subgrouping based on filtering options and dynamic facets together. In particular, the smart organization system 102 generates a modified subgrouping (from a subgrouping or a dynamic facet) by filtering out content items that do not satisfy one or more filtering criteria. FIG. 6 illustrates an example smart organization interface presenting a modified subgrouping in accordance with one or more embodiments.

As illustrated in FIG. 6, the client device 108 displays a smart organization interface 602 that includes a modified subgrouping 608 together with filter options and dynamic facets. In particular, the smart organization system 102 receives user interaction to select a dynamic facet 606 (“Kickoff”) for generating a subgrouping of content items from Collection A. In addition, the smart organization system 102 receives user interaction to select filtering criteria from the filter option 604 (e.g., as shown in FIG. 5). As shown, the smart organization system 102 receives selection of two filtering criteria (“Docs” and one other such as “Presentations”). In some cases, however, the smart organization system 102 receives a selection of a single filtering criterion.

Based on the filtering criteria of the filter option 604, the smart organization system 102 generates the modified subgrouping 608. More specifically, the smart organization system 102 updates or modifies the subgrouping of the dynamic facet 606 to include only content items that not only correspond to the dynamic facet 606 (or to the content attribute of the dynamic facet 606) but that also satisfy the filtering criteria of the filter option 604. For instance, the smart organization system 102 identifies or selects (to include within the modified subgrouping 608) content items that are digital documents or digital presentations and that correspond to the “Kickoff” topic. As shown, the modified subgrouping 608 includes 17 files (from the 178 of the subgrouping 410). As also shown, the smart organization interface 602 also includes a collection creation option 610 for creating a new content collection from the modified subgrouping 608 as displayed.

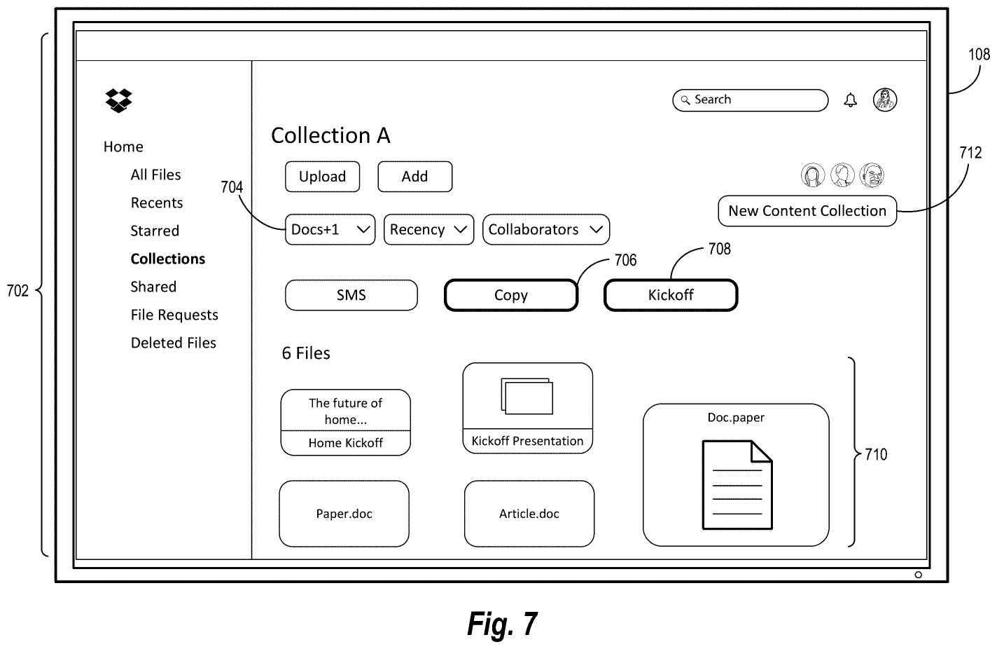

As mentioned, in some embodiments, the smart organization system 102 can modify a subgrouping based on selection of one or more additional dynamic facets. In particular, the smart organization system 102 can receive a selection of an additional dynamic facet to generate a modified subgrouping that includes content items corresponding to a first dynamic facet and the additional dynamic facet. FIG. 7 illustrates an example modified subgrouping for multiple dynamic facets in accordance with one or more embodiments.

As illustrated in FIG. 7, the client device 108 displays a smart organization interface 702 that includes a modified subgrouping 710 together with filter options and dynamic facets. Particularly, the smart organization system 102 generates the modified subgrouping 710 from Collection A. For instance, the smart organization system 102 receives a selection of dynamic facet 708 (“Kickoff”) and generates a subgrouping based on the corresponding content attribute (e.g., the subgrouping 410). In turn, the smart organization system 102 generates a new set of dynamic facets for the newly generated subgrouping. Indeed, the smart organization system 102 analyzes the content items of the subgrouping to determine content attributes and generates new dynamic facets for the content attributes of the subgrouping (which may differ from those of Collection A as a whole).

In addition, the smart organization systems 102 receives a selection of filtering criteria from the filter option 704 to generate a modified subgrouping (e.g., the subgrouping 608) of content items that satisfy the filtering criteria. In some embodiments, the smart organization system 102 further generates updates the dynamic facets to generate a new set based on the subgrouping of content items that satisfy the filtering criteria. Further, the smart organization system 102 receives a selection of the dynamic facet 706 (“Copy”) included among the updated set of dynamic facets for the modified subgrouping. In turn, the smart organization system 102 further modifies the subgrouping to include only content items that correspond to the dynamic facet 706 in addition to the dynamic facet 708 and that satisfy the filtering criteria of the filter option 704. As shown, the modified subgrouping 710 includes 6 files from among the 17 files within the modified subgrouping 608. Additionally, the smart organization interface 702 includes a collection creation interface 712 selectable to create a new content collection from the modified subgrouping 710.

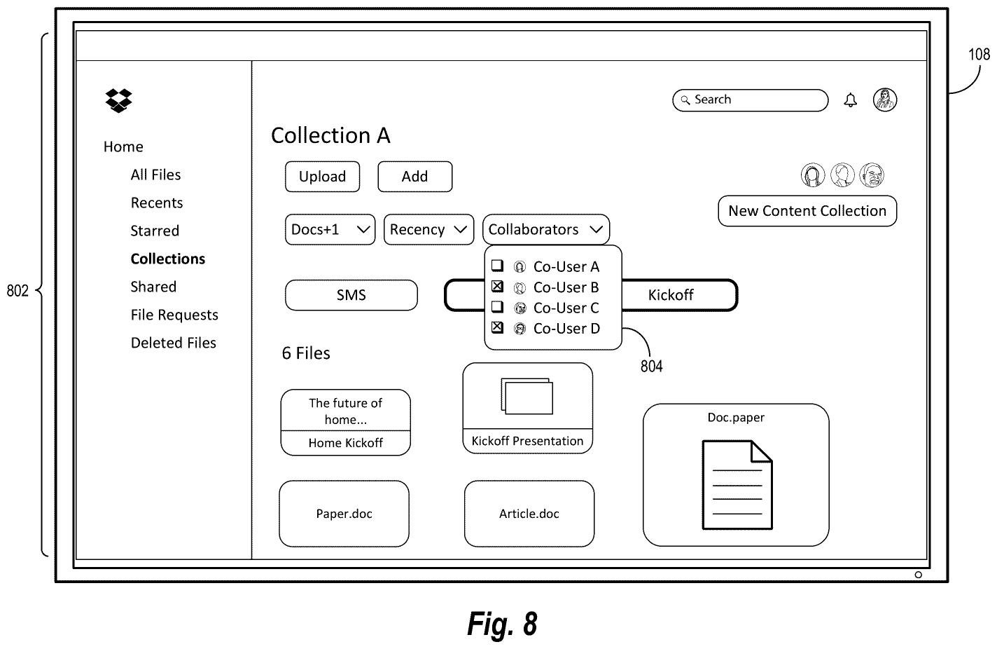

As mentioned, in certain described embodiments, the smart organization system 102 further refines a subgrouping based on additional dynamic facets and/or filtering criteria. For example, the smart organization system 102 receives further interaction to select filtering criteria from additional or alternative filter options. FIG. 8 illustrates an example filter option for modifying a subgrouping according to collaborative co-user accounts associated with content items in accordance with one or more embodiments.

As illustrated in FIG. 8, the client device 108 displays a smart organization interface 802 that includes a subgrouping of content items together with filter options and dynamic facets. In some embodiments, the smart organization system 102 determines a ranking for collaborative co-user accounts. For example, the smart organization system 102 analyzes historical user account activity of a user account to identify co-user accounts with which the user account interacts with the most (or most frequently or most recently or who shares the most content items in common). As another example, the smart organization system 102 determines relationships between user accounts (e.g., where one user account is an administrator a manager over another) and ranks co-user accounts with stronger relationships higher up. The smart organization system 102 can thus provide a listing of collaborative co-user accounts as filtering criteria within an expanded filter option 804 for the “Collaborators” filter option.

As shown, the smart organization system 102 receives a selection of the “Collaborators” filter option and provides the expanded filter option 804 to present corresponding filtering criteria. For example, the smart organization system 102 presents filtering criteria for selecting collaborative co-user accounts. Based on receiving indications for selecting Co-User B and Co-User D, for instance, the smart organization system 102 identifies (collaborative) content items that are accessible by the user account of the client device 108 as well as co-user accounts for Co-User B and Co-User D. The smart organization system 102 can thus update or modify a subgrouping to include only such (collaborative) content items.

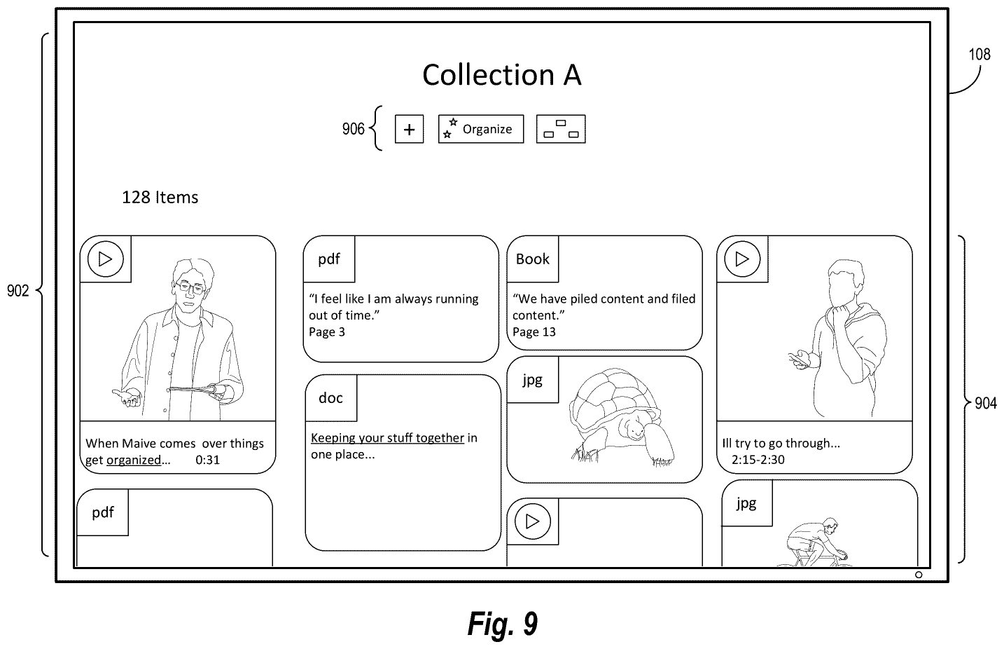

In one or more embodiments, the smart organization system 102 utilizes variations of smart organization interfaces. For example, the smart organization system 102 can provide a smart organization interface that includes content cards representing content items along with variants of selectable interface elements. FIG. 9 illustrates an example smart organization interface for presenting a subgrouping of content items from a content collection in accordance with one or more embodiments.

As illustrated in FIG. 9, the client device 108 displays a smart organization interface 902 that includes a subgrouping 904 corresponding to a dynamic facet. In particular, the smart organization system 102 generates the subgrouping 904 from the content collection, Collection A. In line with the above description, the smart organization system 102 generates the subgrouping 904 based on a dynamic facet. For example, the smart organization system 102 receives a selection of an “Organize” dynamic facet and selects, from Collection A, content items that relate to the content attribute of “Organize.”

Indeed, the smart organization system 102 provides interface elements 906 selectable to generate or modify the subgrouping 904. For instance, the interface elements 906 includes an element (the “+” sign) for adding new content items to the subgrouping 904 or to Collection A. In addition, the interface elements 906 include an option (the center element that says “Organize”) to select a dynamic facet for creating the subgrouping 904. For instance, upon selection of the dynamic facet option, the smart organization system 102 expands the element to present selectable dynamic facets for arranging or organizing content items into the subgrouping 904. As shown, the smart organization system 102 receives a selection of an “Organize” dynamic facet, and the smart organization system 102 generates the subgrouping 904 to include content items corresponding to the dynamic facet. Indeed, the 128 content items within the subgrouping 904 reflect or represent the organization topic or theme of the dynamic facet. Further, the interface elements 906 can include an interface element (the rightmost element with three boxes) to create new content collection from the subgrouping 904.

As shown, the smart organization interface 902 depicts content cards to represent the content items of the subgrouping 904. Indeed, the smart organization system 102 generates content cards of various sizes that are modifiable, manipulable, or otherwise interactive and that link to or reference content items within Collection A. For example, the smart organization system 102 receives user interaction to move content cards from one interface location to another (or to drag a content card to another interface for adding to a different folder or a different collection). As another example, the smart organization system 102 receives a user interaction to hover over a content card, whereupon the smart organization system 102 presents or displays content associated with the content card (e.g., by presenting a digital video or playing an audio clip). As shown, the content cards further include indications of content attributes or other information pertaining to respective content items, such as file types, storage locations, file sizes, and/or timestamps.

In some cases, the smart organization system 102 provides, for display within the subgrouping 904, a content card that represents a portion of a content item. For example, the smart organization system 102 identifies a portion or a segment of a content item that corresponds to a dynamic facet (and/or that satisfies filtering criteria), and the smart organization system 102 includes (a reference to) the portion to include within the subgrouping 904 (excluding other portions of the content item). In certain embodiments, the smart organization system 102 determines one or more content markers such as timestamps designating endpoints of a digital video that define a portion that mentions, discusses, depicts, or otherwise relates to the “Organize” topic. The smart organization system 102 thus provides a content card for the identified portion that is selectable to play the portion of the digital video designated by the timestamps. As shown, the smart organization system 102 identifies a digital video that mentions organization beginning at 0:31, another digital video portion from 2:15-2:30 that discusses organization, and other content items that mention organization at particular pages (as indicated by the PDF representing page 3 of a document or page 13 of the book).

In some cases, the smart organization system 102 further highlights or otherwise indicates, within a content card, relevance of a content item in relation to a selected dynamic facet. For instance, the smart organization system 102 underlines key phrases within content items that corresponding to the “Organize” topic to indicate how or why the smart organization system 102 selected the corresponding content item for the subgrouping 904. In certain embodiments, the smart organization system 102 generates a transcription for a digital video (or a portion of a digital video) and indicates a transcript location that corresponds to the dynamic facet (along with timestamps or other content markers for the endpoints of the segment that corresponds to the dynamic facet).

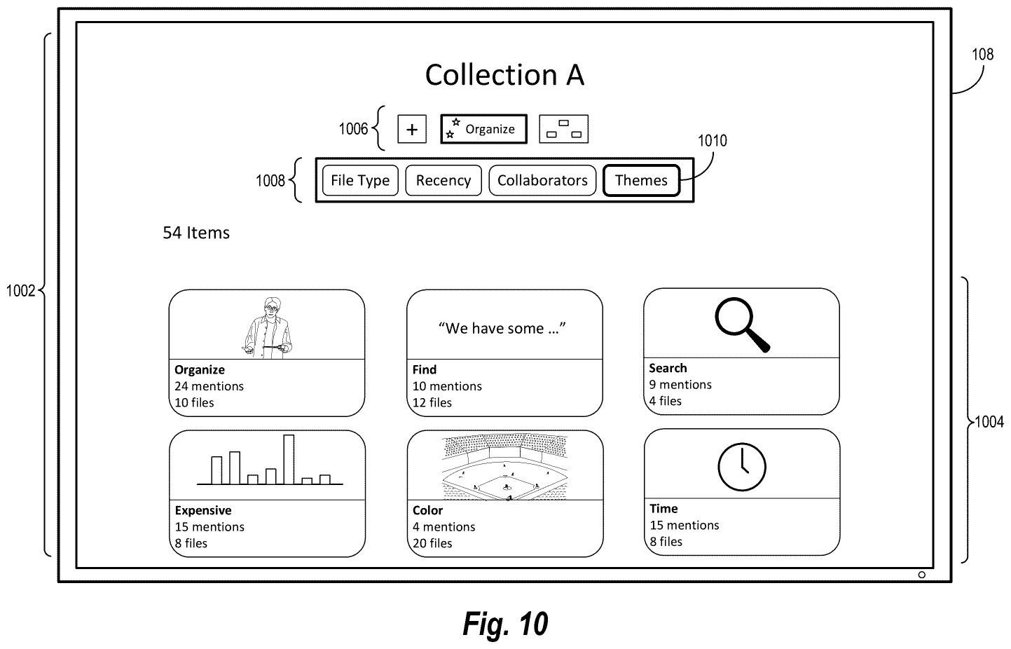

As further mentioned above, in some embodiments, the smart organization system 102 can modify a subgrouping based on user interaction with a filter option. For instance, the smart organization system 102 can provide filter options for display within a user interface to filter by filtering category and/or filtering criteria. FIG. 10 illustrates an example modified subgrouping corresponding to a filter option in accordance with one or more embodiments.

As illustrated in FIG. 10, the client device 108 displays a smart organization interface 1002 that includes a subgrouping 1004 together with interface elements 1006 and filter options 1008. As shown, the smart organization system 102 generates the subgrouping 1004 to include content items corresponding to the “Organize” dynamic facet (as shown within the interface elements 1006) and further arranged according to the filtering category of “Themes” corresponding to the filter option 1010. To elaborate, in some cases, the smart organization system 102 receives a user interaction selecting the filter option 1010, whereupon the smart organization system 102 organizes content items into a number of sets specific to the indicated filtering category (“Themes”).

As indicated in FIG. 10, the smart organization system 102 organizes the content items into theme-based content sets corresponding to themes such as “Organize,” “Find,” “Search,” “Expensive,” “Color, and “Time.” To generate the content sets according to a filtering category, the smart organization system 102 determines relationships between content items and the selected filtering category. For instance, the smart organization system 102 generates category-specific embeddings for the content items (e.g., using a content embedding machine learning model to generate theme-specific clusters) according to the filtering category (“Themes”) and generates embedding clusters for content items within the embedding space. The smart organization system 102 further generates the content sets to reflect content items of the different embedding clusters.

In certain cases, the smart organization system 102 also generate content sets for different filtering categories. For instance, based on user selection of the “File Type” filter option, the smart organization system 102 arranges content items by file type (e.g., “documents,” “videos,” etc.) by clustering embeddings (or by some other method). Likewise for other filter options, the smart organization system 102 generates content sets for corresponding filtering categories (e.g., “Recency” or “Collaborators”). In addition, the smart organization system 102 provides visual indications of how many content items belong to each of the sets.

Further, the smart organization system 102 provides visual indications of numbers of mentions corresponding to each content set, indicating the number of times a content attribute associated with the selected dynamic facet (“Organize”) is mentioned. Indeed, the smart organization system 102 determines a number of content attribute mentions (or dynamic facet mentions) within content items and provides a visualization of the number for the content set as a whole. In some cases, the smart organization system 102 utilizes natural language processing to identify dynamic facet mentions by identifying key phrases within content items that are within a threshold similarity of the selected dynamic facet (or the content attribute of the selected dynamic facet). For instance, the smart organization system 102 identifies exact matches of the word “organize” or its variants (e.g., “organization,” “organizes,” “organizing,” etc.) as well as other phrases that, according to natural language processing, have meanings within a threshold similarity (e.g., “arrange,” “neatly place,” etc.). In some embodiments, the smart organization system 102 determines mentions by comparing depicted objects within content items (e.g., images or videos) with a content attribute of a dynamic facet (e.g., a key phrase or image) to identify similar objects or image themes using object similarity analysis or image comparison analysis.

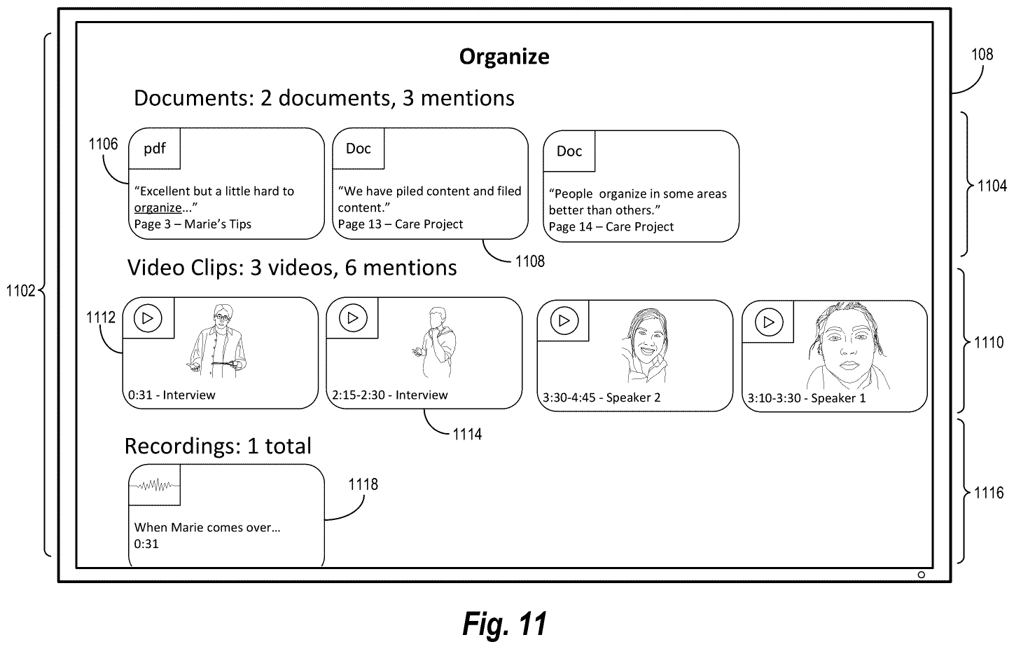

Upon selection of a content set within the subgrouping 1004, the smart organization system 102 can provide a more detailed breakdown of the content items within the set. For example, based on user interaction selecting the “Organize” content set from the smart organization interface 1002, the smart organization system 102 generates and provides a user interface that includes additional details for the content items therein. FIG. 11 illustrates an example content breakdown interface in accordance with one or more embodiments.

As illustrated in FIG. 11, the client device 108 displays a content breakdown interface 1102 that includes indications of different file types for the content items within the “Organize” content set. As shown, the smart organization system 102 breaks down the content set to display documents within a document section 1104, video clips within a video section 1110, recordings within a recordings section 1116, and/or other file types within the content breakdown interface 1102. For each of the content item sections, the smart organization system 102 visually indicates the number of content items within each section (corresponding to each file type), along with the number of times the selected dynamic facet (or the content attribute of the dynamic facet) is mentioned.

Within the document section 1104, the smart organization system 102 provides content cards such as content card 1106 and content card 1108 that represent respective content items. As shown, the smart organization system 102 generates the content cards to indicate file types and to highlight portions of the content items that mention the content attribute of the dynamic facet. In some cases, the smart organization system 102 provides only those portions of the content items that include the mentions and excludes unrelated portions. As shown in the document section 1104, the smart organization system 102 identifies two documents that mention the “Organize” content attribute a total of three times. The first document is called “Marie's Tips” and corresponds to the content card 1106 and mentions organization on page three. The second document is called “Care Project” and includes two mentions, one on page thirteen as indicated by the content card 1108 and another on page fourteen as indicated by the third content card within the document section 1104.

Within the video section 1110, the smart organization system 102 provides content cards corresponding to video clips that include mentions (or depictions) of the (content attribute of the) selected dynamic facet. For example, the smart organization system 102 identifies a total of three digital videos or portions of digital videos that mention the content attribute of the dynamic facet (“Organize”). The smart organization system 102 further indicates that the digital videos include a total of six mentions among them. Accordingly, the smart organization system 102 provides a content card (and/or generates a video portion) for each of the six mentions, where each of the content cards is interactive to present or play its respective video portion (from a first endpoint to a second endpoint).

As shown, the smart organization system 102 generates and provides the content card 1112 and the content card 1114 for video portions from the same digital video titled “Interview.” The smart organization system 102 determines that a first mention in the digital video begins or occurs at 0:31 within the digital video, as reflected by the content card 1112. In addition, the smart organization system 102 determines that a second mention occurs between timestamps 2:15 and 2:30 of the digital video, as reflected by the content card 1114. The smart organization system 102 thus generates content cards (as metadata layers) indicating respective portions of a digital video and that are manipulable and interactive as individual digital videos themselves. The content cards can also be playable to view the corresponding portions of the digital video.

Within the recordings section 1116, the smart organization system 102 provides a content card 1118 for an audio recording that mentions the “Organize” attribute of the selected dynamic facet. Indeed, the smart organization system 102 determines a timestamp within the recording associated with the content attribute (e.g., 0:31). Specifically, the smart organization system 102 determines a timestamp where the key phrase occurs or where a sentence that includes the key phrase begins or where a discussion begins that includes the key phrase. In addition, the smart organization system 102 generates and provides a transcription of the audio recording (or the relevant portion of the audio recording) within the content card 1118.

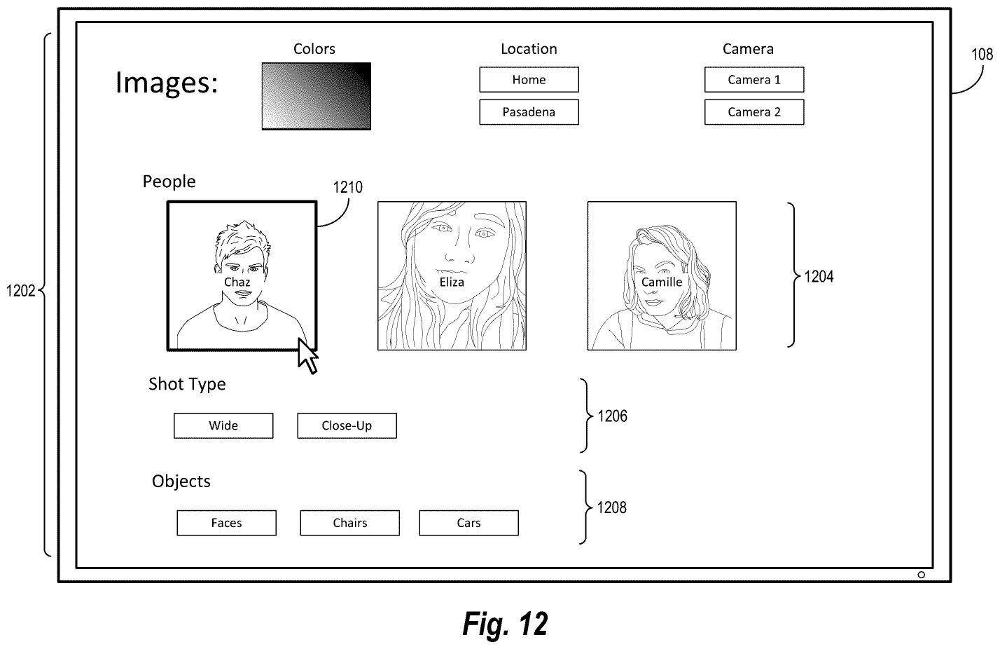

In certain described embodiments, the smart organization system 102 provides different layouts for a smart organization interface for different types of content items. For example, the smart organization system 102 generates a smart organization interface that is specific to digital images. FIG. 12 illustrates an example smart organization interface specific to digital images in accordance with one or more embodiments.

As illustrated in FIG. 12, the client device 108 displays a smart organization interface 1202 that is specific to organizing and viewing digital images. Indeed, the smart organization system 102 generates and provides the smart organization interface 1202 in response to detecting or determining that a content collection includes at least a threshold number (or a threshold proportion, ratio, or percentage) of digital images. As shown, the smart organization system 102 provides selectable elements for arranging or organizing content items (e.g., digital images) according to colors, location, and camera. In certain embodiments, the smart organization system 102 generates different subgroupings of digital images for the different content attributes of the images.

For example, based on a selection of the “Colors” element, the smart organization system 102 can organize digital images according to colors they depict. Indeed, the smart organization system 102 can utilize a content attribute machine learning model to determine colors depicted within a digital image. In some cases, the smart organization system 102 classifies digital images according to a most prominent color.

In addition, in response to a selection of a location option (e.g., “Home” or “Pasadena” or some other location), the smart organization system 102 can select a subset of digital images that correspond to the selected location. For instance, the smart organization system 102 can determine content attributes such as geotags that indicate locations where digital images are captured, and the smart organization system 102 can provide digital images that correspond to a selected location. In some cases, the smart organization system 102 can further generate the location elements based on locations associated with digital images of a content collection.

Further, the smart organization system 102 can generate and provide camera elements as well (e.g., “Camera 1” and “Camera 2”). The camera elements can indicate different cameras used to capture digital images. For example, the smart organization system 102 can determine a camera make and model used to capture a digital image and can provide the camera options for arranging content items based on camera type. Thus, based on a selection of a camera option, the smart organization system 102 can arrange digital images according to which cameras were used to capture the digital images. The smart organization interface 1202 can include additional or alternative organization elements as well.

As further illustrated in FIG. 12, the smart organization system 102 determines different people (or other objects) depicted in digital images. For example, the smart organization system 102 analyzes digital images (e.g., via a content attribute machine learning model) to identify different people or other objects depicted within the digital images. Based on detecting different faces (or other objects), the smart organization system 102 generates and provides the people section 1204 within the smart organization interface 1202 that includes selectable elements corresponding to different people. In some cases, instead of the people section 1204, the smart organization system 102 can provide an objects section for image sets depicting different objects. As shown, the smart organization system 102 identifies faces of three different individuals, “Chaz,” “Eliza,” and “Camille,” and the smart organization system 102 provides corresponding interface elements to view additional breakdowns of the corresponding digital images. In addition, the smart organization system 102 receives a selection of the “Chaz” element.

As further illustrated in FIG. 12, the smart organization system 102 provides a shot type section 1206 within the smart organization interface 1202. Indeed, the smart organization system 102 analyzes digital images utilizing a content attribute machine learning model to determine a shot type (as a content attribute), such as a wide angle shot, a close-up, a selfie, or some other shot type. Based on user selection of a shot type element (e.g., “Wide” or “Close-up”), the smart organization system 102 can provide a breakdown interface for digital images corresponding to the selected shot type.

As mentioned, the smart organization system 102 can determine or identify objects depicted within digital images. For instance, the smart organization system 102 can utilize a content attribute machine learning model to detect and label objects depicted within digital images. Based on detected objects, the smart organization system 102 can generate an objects section 1208 that includes object elements such as “Faces,” “Chairs,” and “Cars” selectable to view additional details for digital images depicting the respective objects. The smart organization system 102 can further provide other sections within the smart organization interface 1202 as well. Indeed, the smart organization system 102 can provide respective sections for different content attributes associated with digital images.

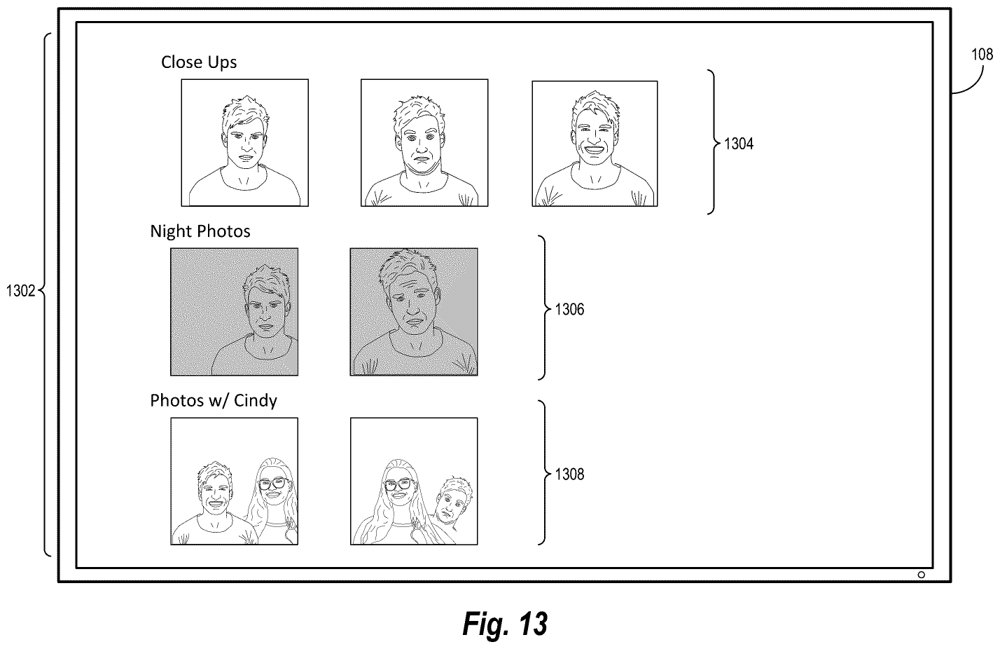

Based on receiving the selection of the “Chaz” element 1210, the smart organization system 102 generates and provides a content breakdown interface for digital images depicting a person or a face labeled as “Chaz.” In particular, the smart organization system 102 provides additional details for images depicting Chaz within a content breakdown interface. FIG. 13 illustrates an example content breakdown interface specific to digital images in accordance with one or more embodiments.

As illustrated in FIG. 13, the client device 108 displays a content breakdown interface 1302 specific to digital images for the “Chaz” interface element. As shown, the smart organization system 102 breaks down a set of digital images that each depict “Chaz” into various sections according to content attributes, such as a close ups section 1304, a night photos section 1306, and an additional person section 1308. The smart organization system 102 can further generate and provide additional sections based on respective content attributes as well.

Within the close ups section 1304, the smart organization system 102 provides a number of digital images that are labeled as close up images. Indeed, the smart organization system 102 utilizes a content attribute machine learning model to analyze digital images and determine which digital images are close ups. Similarly, the smart organization system 102 analyzes digital images to identify which one are night photos to include within the night photos section 1306. Likewise, the smart organization system 102 determines which photos of Chaz also depict Cindy to include within the additional person section 1308 (where the additional person section 1308 is specific to a certain individual as the additional person).

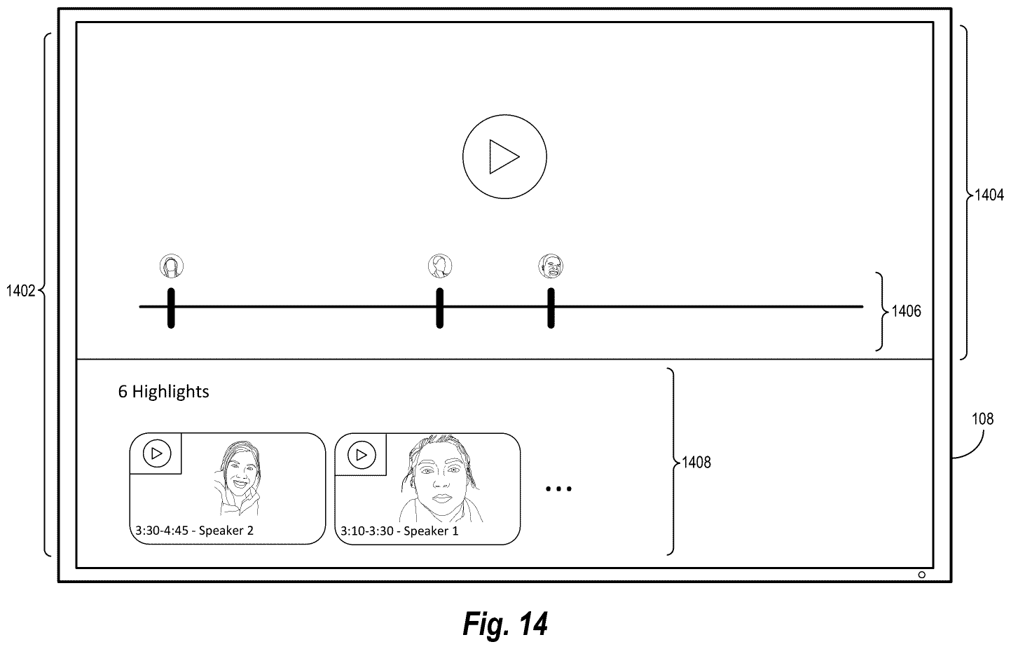

As mentioned above, in certain described embodiments, the smart organization system 102 can include portions of content items within a subgrouping. In particular, the smart organization system 102 can generate or determine portions of content items that correspond to content attributes to include within a subgrouping. FIG. 14 illustrates an example digital video portion interface in accordance with one or more embodiments.

As illustrated in FIG. 14, the client device 108 displays a digital video portion interface 1402 that includes a video section 1404 for playing a digital video along with content portions 1408 indicating different segments of the digital video that correspond to a content attribute. For instance, based on receiving a user interaction to select a digital image (e.g., from the video section 1110) from a subgrouping (or from a content collection), the smart organization system 102 provides the digital video portion interface 1402. In some cases, the smart organization system 102 provides the digital video portion interface 1402 for playing an entire digital video that includes, or is reference by, a selected content item element (e.g., from the video section 1110). In other cases, the smart organization system 102 provides the digital video portion interface 1402 for playing only the portion of the digital video (e.g., excluding portions unrelated to a content attribute or a dynamic facet).

Within the digital video portion interface 1402, the smart organization system 102 provides a timeline 1406 that indicates timestamps or video locations where content attribute mentions occur (or where a sentence or a discussion begins that includes the content attribute mention). Indeed, the smart organization system 102 performs content synthesis to generate or determine content portions associated with a dynamic facet. For example, the smart organization system 102 analyzes a digital video to determine mentions of a content attribute of a selected dynamic facet. In some cases, the smart organization system 102 utilizes a content attribute machine learning model to analyze the digital video to identify relevant portions and irrelevant portions. In some embodiments, the smart organization system 102 generates the relevant portions as mutually exclusive so that the content portions 1408 do not overlap with one another. The smart organization system 102 further provides timeline indicators on the timeline 1406 that indicate timestamps together with images of individuals (e.g., user accounts within the content management system 106) speaking at the respective timestamp locations.

Additionally, the smart organization system 102 provides content portions 1408 that correspond to the timeline 1406 and that are selectable to view the video portions corresponding to a particular content attribute (e.g., of a selected dynamic facet). Indeed, the smart organization system 102 determines portions of a digital video that mention or otherwise correspond to a content attribute of a dynamic facet. Further, based on a selection of a content portion, the smart organization system 102 plays the content portion within the video section 1404.

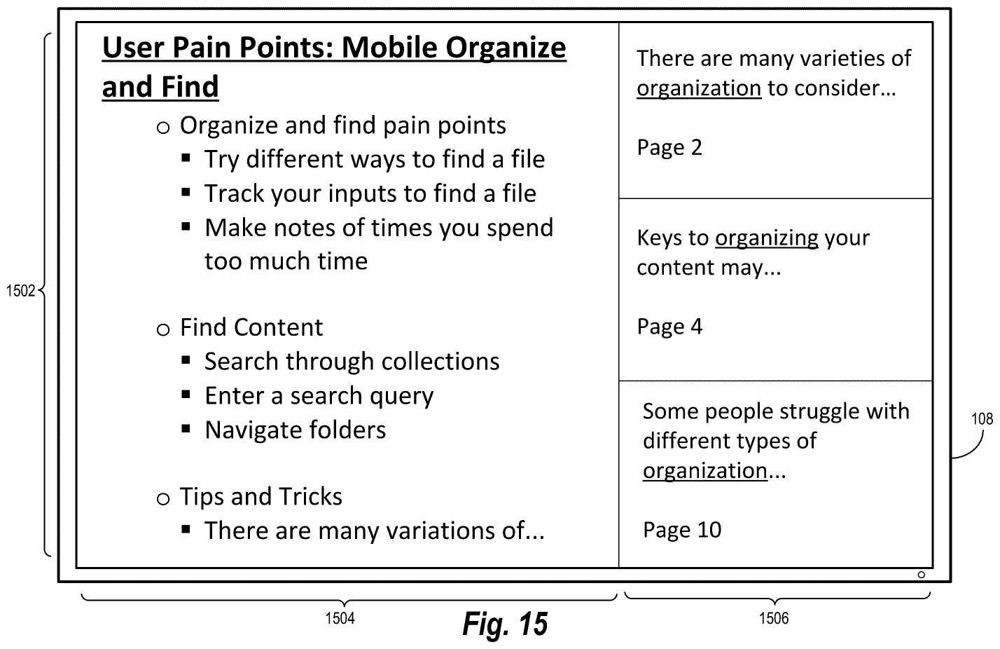

In some embodiments, the smart organization system 102 can utilizes content synthesis to determine content portions for content items other than digital videos. For example, the smart organization system 102 can identify portions of content items corresponding to a content attribute of a dynamic facet within audio clips, digital documents, or other types of content items. FIG. 15 illustrates an example document portion interface in accordance with one or more embodiments.

As illustrated in FIG. 15, the client device 108 displays a document portion interface 1502 that includes a document visualization 1504 together with document portion section 1506. Within the document portion section 1506, the smart organization system 102 provides selectable options for locating or accessing corresponding content portions within the digital document of the document visualization 1504. For example, the smart organization system 102 analyzes the digital document “User Pain Points: Mobile Organize and Find” to determine portions of the digital document that mention or otherwise correspond to a content attribute of a selected dynamic facet. As shown, the smart organization system 102 identifies content portions associated with the “Organize” content attribute and indicates locations (e.g., page numbers) of the content portions within the digital document.

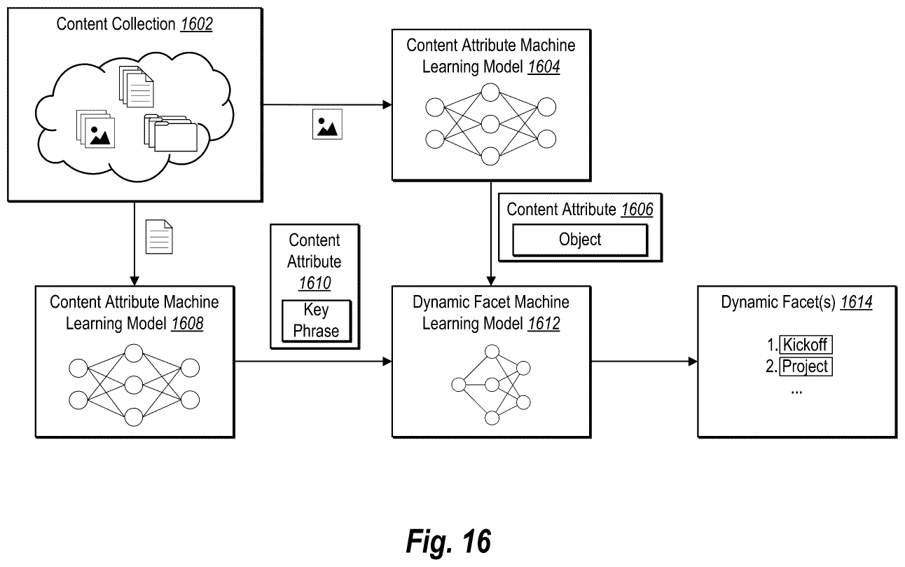

As mentioned above, in certain described embodiments, the smart organization system 102 generates dynamic facets for a content collection or for a subgrouping of content items. In particular, the smart organization system 102 determines content attributes for content items and further generates dynamic facets from the determined content attributes. FIG. 16 illustrates an example sequence diagram for generating dynamic facets from content attributes in accordance with one or more embodiments.

As illustrated in FIG. 16, the smart organization system 102 identifies a content collection 1602. In particular, the smart organization system 102 identifies a content collection 1602 associated with a user account of the content management system 106 and that includes a plurality of content items. As shown, the smart organization system 102 further determine s content attributes associated with the content items within the content collection 1602 for generating dynamic features. For instance, the smart organization system 102 determines descriptive attributes and relevance attributes (e.g., relative to a user account) for each of the content items within the content collection 1602.

To elaborate, as illustrated in FIG. 16, the smart organization system 102 utilizes a content attribute machine learning model 1604 to extract, determine, or predict a content attribute 1606 for a digital image content item. For example, the smart organization system 102 utilizes the content attribute machine learning model 1604 trained on sample content items and corresponding indications of ground truth content attributes associated with the sample content items. In some cases, the smart organization system 102 utilizes the content attribute machine learning model 1604 to generate the content attribute 1606 according to its learned parameters such as internal weights and biases. As shown, the content attribute 1606 is an object depicted in the digital image. The content attribute 1606 can reflect a word or phrase describing the depicted object or can reflect an image of a depicted object.

Additionally, the smart organization system 102 utilizes a content attribute machine learning model 1608 to generate or predict the content attribute 1610 from a digital document. For instance, the smart organization system 102 utilizes the content attribute machine learning model 1608 trained on to generate content attributes such as key phrases from sample documents. As shown, the smart organization system 102 generate the content attribute 1610 in the form of a key phrase describing all or part of the content item (e.g., describing a topic or theme). For instance, the smart organization system 102 generates key phrases corresponding to an entire content item or corresponding to a portion of a content item. To select a content item for a subgrouping, the smart organization system 102 can also compare the key phrases associated with different portions of a content item with a key phrase associated with the dynamic facet. The smart organization system 102 can further determine or predict other types of content attributes as well, and for other types of content items (e.g., using different content attribute machine learning models for different content types and/or different content attributes).

As further illustrated in FIG. 16, the smart organization system 102 utilizes a dynamic facet machine learning model 1612 to generate one or more dynamic facets 1614. For example, the smart organization system 102 utilizes the dynamic facet machine learning model 1612 to determine content attributes to ascribe to the content collection 1602 as a whole. To generate the dynamic facets 1614, the smart organization system 102 determines key phrases or objects or other visual representations of content attributes to include within the dynamic facets 1614. For instance, the smart organization system 102 generates a key phrase using the dynamic facet machine learning model 1612 and/or natural language processing to determine words describing content attributes. In addition, the smart organization system 102 determines a measure of prominence within the content collection 1602 associated with a content attribute. For instance, the smart organization system 102 determines a number of instances that individual content attributes occur within the content collection 1602.

The smart organization system 102 can also (or alternatively) determine a measure of relevance for a content attribute in relation to a user account (e.g., based on historical user account activity with content items reflecting the content attribute). In some cases, the smart organization system 102 further ranks the content attributes according to relevance and/or prominence. The smart organization system 102 thus generates the dynamic facets 1614 to indicate content attributes with at least a threshold measure of prominence and/or a threshold measure of relevance (discarding other content attributes). The smart organization system 102 can further provide the dynamic facets 1614 for display in ranked order. As mentioned, the smart organization system 102 can further update or modify sets of dynamic facets (or generate new sets of dynamic facets) for different subgroupings of content items (e.g., based on a selection of a dynamic facet).

As mentioned, the smart organization system 102 can also determine content attributes for discrete portions of content items as well. In particular, the smart organization system 102 can utilize a content attribute machine learning model to generate or predict a content attribute for a content portion, where the model is trained to not only identify the content attribute but also to determine a location of the content attribute within the content item. In cases where a content item includes multiple mentions of a content attribute, the smart organization system 102 can further train and utilize the content attribute machine learning model to identify the various portions reflecting the content attribute, where the portions are mutually exclusive and do not overlap one another.

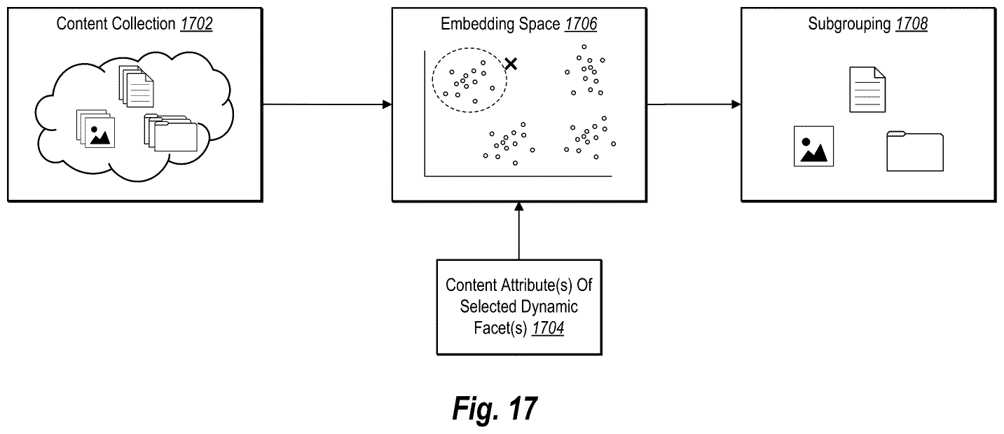

As mentioned above, in certain described embodiments, the smart organization system 102 can generate a subgrouping of content items from a content collection. In particular, the smart organization system 102 can generate a subgrouping of content items by selecting content items that reflect or otherwise correspond to a particular content attribute (e.g., from a selected dynamic facet). FIG. 17 illustrates an example sequence diagram for generating a subgrouping from a content collection in accordance with one or more embodiments.

As illustrated in FIG. 17, the smart organization system 102 identifies a content collection 1702. In addition, the smart organization system 102 generates embeddings (e.g., vector representations) for content items within the content collection 1702. For example, the smart organization system 102 utilizes a content embedding machine learning model to extract, encode, or generate a semantic embedding for a content item (e.g., within an embedding space 1706 or a vector space). In some cases, an embedding refers to a numerical or mathematical representation of a content item that describes or represents the content item, reflecting or representing visual and/or un-observable traits (e.g., a semantic description) of the content item. In some cases, the smart organization system 102 generates embeddings for portions of content items (e.g., portions determined to reflect or mention content attributes).

As shown, the smart organization system 102 further generates, extracts, or encodes embeddings for content attributes. For example, the smart organization system 102 generates an embedding for a content attribute 1704 of a selected dynamic facet. For instance, the smart organization system 102 generates embeddings from key phrases, from objects, from images, or from other representations of content attributes. The smart organization system 102 thus compares the embedding of the content attribute with the embeddings of content items from the content collection 1702. For illustrative purposes, the embedding space 1706 shown in FIG. 17 is a two-dimensional space, though the embedding space 1706 can have many dimensions. Within the embedding space 1706, the smart organization system 102 generates embeddings for content items represented by the small dots or circles within the embedding space 1706. Additionally, the embedding space 1706 represents the embedding for the content attribute 1704 of the selected dynamic facet using the “X” symbol.

In some embodiments, the smart organization system 102 generates the subgrouping 1708 from the embeddings in the embedding space 1706. In particular, the smart organization system 102 selects, as content items to include within the subgrouping 1708, content items corresponding to embeddings within a threshold distance (or a threshold similarity) of the content attribute embedding within the embedding space 1706. For example, the smart organization system 102 determines distances between embeddings within the embedding space 1706 and selects content items whose embeddings are within a threshold distance of the content attribute embedding.

In certain cases, the smart organization system 102 determines or generates clusters of embeddings. For example, the smart organization system 102 uses a clustering technique or a content embedding machine learning model to cluster embeddings according to relative distances (or similarities) between them within the embedding space 1706. In some embodiments, the smart organization system 102 selects content items for the subgrouping 1708 by selecting a cluster of embeddings from the embedding space 1706 that is within a threshold distance (or a threshold similarity) of the content attribute embedding. As shown, the smart organization system 102 identifies the cluster outlined in a dashed circle as including or indicating content items for the subgrouping 1708. Accordingly, the smart organization system 102 determines content items for the subgrouping 1708 by selecting content items from the content collection 1702 that correspond to the content attribute 1704 of the selected dynamic facet.

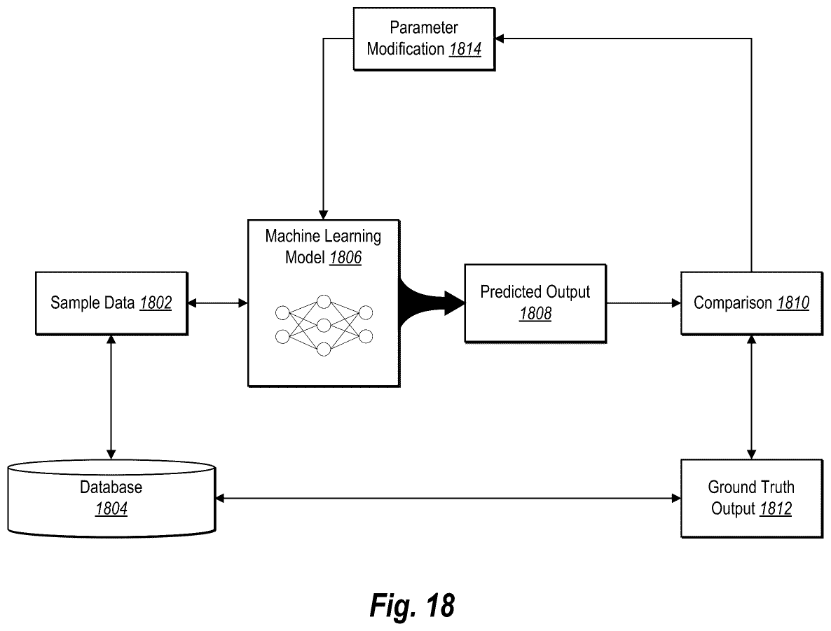

In certain described embodiments, the smart organization system 102. In particular, FIG. 18 illustrates an example sequence diagram for training a machine learning model (e.g., a content attribute machine learning model, a dynamic facet machine learning model, or a content embedding machine learning model) in accordance with one or more embodiments. In some cases, the smart organization system 102 trains the machine learning model 1806 such as a neural network to have internal parameters such as weight and biases for generating a predicted output 1808 (e.g., a predicted content attribute, a predicted dynamic facet, or an embedding) based on training data.

As shown, the smart organization system 102 accesses sample data 1802 from a database 1804 (e.g., the database 114). For example, the smart organization system 102 determines sample data 1802 such as sample content items, sample content attributes, or some other sample data to input into the machine learning model 1806. In some embodiments, the smart organization system 102 utilizes the machine learning model 1806 to generate a predicted output 1808 from the sample data 1802. Specifically, the machine learning model 1806 generates a predicted output 1808 according to its internal parameters.

As part of training the machine learning model 1806, the smart organization system 102 performs a comparison 1810. Specifically, the smart organization system 102 compares the predicted output 1808 with a ground truth output 1812 (e.g., a ground truth content attribute to compare with a predicted content attribute, a ground truth dynamic facet to compare with a predicted dynamic facet, or a ground truth embedding to compare with a predicted embedding). Indeed, the smart organization system 102 accesses the ground truth output 1812 from the database 1804, where the ground truth output 1812 is designated as corresponding to the sample data 1802. In some cases, the smart organization system 102 performs the comparison 1810 using a loss function such as a mean squared error loss function or a cross entropy loss function to determine an error or a measure of loss associated with the machine learning model 1806 (or between the predicted output 1808 and the ground truth output 1812).

In one or more embodiments, the smart organization system 102 further performs a parameter modification 1814. Based on the comparison 1810, the smart organization system 102 modifies parameters of the machine learning model 1806. For example, the smart organization system 102 modifies parameters of the machine learning model 1806 to reduce a measure of error or a loss associated with the machine learning model 1806. The smart organization system 102 can further repeat the process illustrated in FIG. 18 for many iterations or epochs until the machine learning model 1806 satisfies a threshold measure of loss. For each iteration, the smart organization system 102 generates new predictions from new sample data, performs a comparison, and modifies parameters (e.g., via back propagation) to improve predictions for subsequent iterations.

The components of the smart organization system 102 can include software, hardware, or both. For example, the components of the smart organization system 102 can include one or more instructions stored on a computer-readable storage medium and executable by processors of one or more computing devices. When executed by one or more processors, the computer-executable instructions of the smart organization system 102 can cause a computing device to perform the methods described herein. Alternatively, the components of the smart organization system 102 can comprise hardware, such as a special purpose processing device to perform a certain function or group of functions. Additionally or alternatively, the components of the smart organization system 102 can include a combination of computer-executable instructions and hardware.

Furthermore, the components of the smart organization system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the smart organization system 102 may be implemented as part of a stand-alone application on a personal computing device or a mobile device.

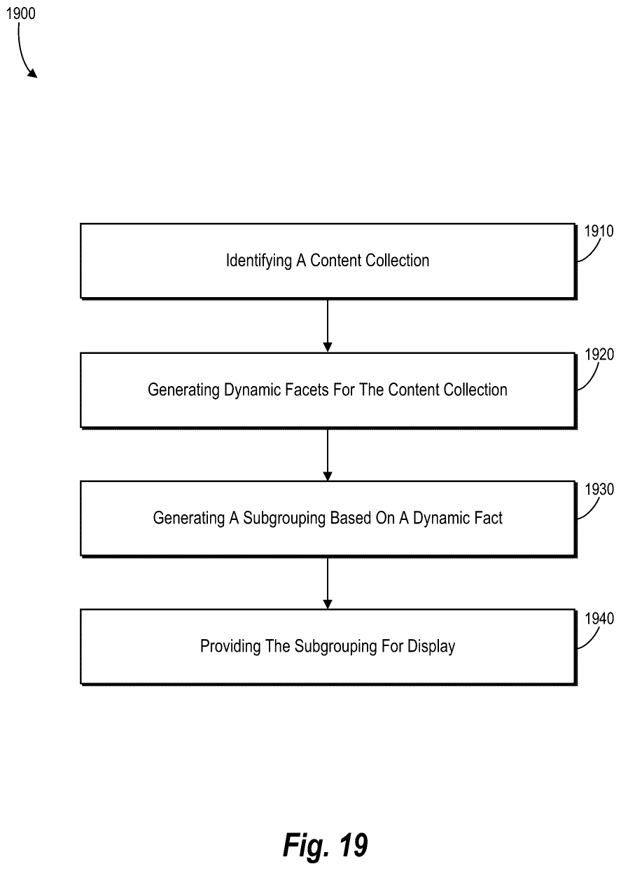

FIGS. 1-18, the corresponding text, and the examples provide a number of different systems and methods for generating and providing subgroupings of content items based on content synthesis and dynamic facets. In addition to the foregoing, implementations can also be described in terms of flowcharts comprising acts steps in a method for accomplishing a particular result. For example, FIG. 19 illustrates an example series of acts for generating and providing subgroupings of content items based on content synthesis and dynamic facets.

While FIG. 19 illustrates acts according to certain implementations, alternative implementations may omit, add to, reorder, and/or modify any of the acts shown in FIG. 19. The acts of FIG. 19 can be performed as part of a method. Alternatively, a non-transitory computer readable medium can comprise instructions, that when executed by one or more processors, cause a computing device to perform the acts of FIG. 19. In still further implementations, a system can perform the acts of FIG. 19.

As illustrated in FIG. 19, the series of acts 1900 may include an act 1910 of identifying a content collection. In particular, the act 1910 can involve identifying a content collection comprising a plurality of content items associated with a user account within a content management system.

In addition, the series of acts 1900 includes an act 1920 of generating dynamic facets for the content collection. In particular, the act 1920 can involve generating, utilizing a dynamic facet machine learning model trained to predict dynamic facets from content attributes associated with content items, a plurality of dynamic facets indicating content attributes associated with the plurality of content items and selectable to arrange the plurality of content items into respective subgroupings. For example, the act 1920 can involve utilizing the dynamic facet machine learning model to generate predicted key phrases from content within the plurality of content items.

Further, the series of acts 1900 includes an act 1930 of generating a subgrouping based on a dynamic facet. In particular, the act 1930 can involve, based on receiving an indication of a user interaction selecting a dynamic facet from the plurality of dynamic facets, generating a subgrouping of content items from among the plurality of content items within the content collection and including content items associated with a content attribute of the dynamic facet. For example, the act 1930 can involve generating embeddings for the content attributes associated with the plurality of content items and comparing, in a vector space, the embeddings for the content attributes associated with the plurality of content items with an embedding for the content attribute of the dynamic facet.

In some cases, the act 1930 can involve generating embeddings for the plurality of content items, clustering the embeddings for the plurality of content items according to relative distances to one another within an embedding space, and selecting, as the subgrouping for the dynamic facet, a subgrouping corresponding to a cluster with a smallest distance from an embedding for the content attribute of the dynamic facet.

As further illustrated in FIG. 19, the series of acts 1900 includes an act 1940 of providing the subgrouping for display. In particular, the act 1940 can involve providing the subgrouping for display within a smart organization interface displayed on a client device associated with the user account.

In some embodiments, the series of acts 1900 includes an act of providing, for display together with the plurality of dynamic facets within the smart organization interface displayed on the client device, one or more filter options selectable to filter the subgrouping according to respective filtering categories. In addition, the series of acts 1900 can include an act of, based on receiving an indication of a user interaction selecting a filter option, providing a set of filtering criteria within a filtering category associated with the filter option. The series of acts 1900 can also or alternatively include an act of, based on receiving an indication of a user interaction selecting a filtering option from the one or more filter options, modifying the subgrouping by removing content items that do not satisfy one or more filtering criteria associated with the filtering option.

Further, the series of acts 1900 can include an act of, based on receiving an indication of a user interaction selecting a filtering criterion from the set of filtering criteria of the filter option, modifying the subgrouping by removing content items that do not satisfy the filtering criterion. Providing the one or more filter options can include providing one or more of: a theme filter option for filtering content items according to various themes, a file type filter option for filtering content items according to file type, a recency filter option for filtering content items according to recency of user account activity with respect to the plurality of content items, or a collaborators filter option for filtering content items according to collaborative co-user accounts within the content management system.

The series of acts 1900 can also include an act of providing, for display within the smart organization interface, a collection creation option selectable to generate a new content collection and an act of, based on receiving an indication of a user interaction selecting the collection creation option, generating a new content collection from the subgrouping of content items for the user account within the content management system. The series of acts 1900 can further include an act of, based on generating the subgrouping of content items, generating an updated set of dynamic facets indicating content attributes associated with the subgrouping of content items.

In some cases, the series of acts 1900 can include an act of identifying, from the plurality of content items, a portion of a content item corresponding to the content attribute of the dynamic facet. The series of acts 1900 can also include an act of providing the portion of the content item as part of the subgrouping for display within the smart organization interface. Identifying a portion of a content item corresponding to a content attribute of a dynamic facet can include determining key phrases associated with different portions of the content item and further include comparing the key phrases associated with the different portions of the content item with a key phrase associated with the dynamic facet. The series of acts can also include an act of providing the portion of the digital video as part of the subgrouping of content items by generating content markers designating endpoints of the portion of the digital video, wherein the content markers limit presentation of the digital video to the portion between the endpoints.

The series of acts 1900 can also include an act of ranking the plurality of dynamic facets according to relevance in relation to the user account of the content management system or according to prominence of respective content attributes within the plurality of content items. Further, the series of acts 1900 can include an act of, based on ranking the plurality of dynamic facets, providing a set of top ranked dynamic facets for display within the smart organization interface. In some cases, the series of acts 1900 includes acts of generating an updated set of dynamic facets based on generating the subgrouping of content items, determining a ranking of the updated set of dynamic facets according to one or more ranking parameters, and providing the updated set of dynamic facets for display within the smart organization interface in a ranked order based on the ranking.

The series of acts 1900 can include an act of providing, for display within the smart organization interface, a collection creation option selectable to generate a new content collection. In addition, the series of acts 1900 can include an act of generating, for the user account within the content management system and based on receiving an indication of a user interaction selecting the collection creation option, a new content collection to include the subgrouping of content items. The series of acts 1900 can also include an act of receiving an indication of a user interaction selecting an additional dynamic facet associated with the subgrouping of content items and an act of, based on receiving the indication of the user interaction selecting the additional dynamic facet, generating a modified subgrouping of content items to include content items from the plurality of content items associated with both the content attribute of the dynamic facet and an additional content attribute of the additional dynamic facet.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 20 illustrates a block diagram of exemplary computing device 2000 (e.g., the server(s) 104 and/or the client device 108) that may be configured to perform one or more of the processes described above. One will appreciate that server(s) 104 and/or the client device 108 may comprise one or more computing devices such as computing device 2000. As shown by FIG. 20, computing device 2000 can comprise processor 2002, memory 2004, storage device 2006, I/O interface 2008, and communication interface 2010, which may be communicatively coupled by way of communication infrastructure 2012. While an exemplary computing device 2000 is shown in FIG. 20, the components illustrated in FIG. 20 are not intended to be limiting. Additional or alternative components may be used in other implementations. Furthermore, in certain implementations, computing device 2000 can include fewer components than those shown in FIG. 20. Components of computing device 2000 shown in FIG. 20 will now be described in additional detail.

In particular implementations, processor 2002 includes hardware for executing instructions, such as those making up a computer program. As an example and not by way of limitation, to execute instructions, processor 2002 may retrieve (or fetch) the instructions from an internal register, an internal cache, memory 2004, or storage device 2006 and decode and execute them. In particular implementations, processor 2002 may include one or more internal caches for data, instructions, or addresses. As an example and not by way of limitation, processor 2002 may include one or more instruction caches, one or more data caches, and one or more translation lookaside buffers (TLBs). Instructions in the instruction caches may be copies of instructions in memory 2004 or storage device 2006.

Memory 2004 may be used for storing data, metadata, and programs for execution by the processor(s). Memory 2004 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 2004 may be internal or distributed memory.

Storage device 2006 includes storage for storing data or instructions. As an example and not by way of limitation, storage device 2006 can comprise a non-transitory storage medium described above. Storage device 2006 may include a hard disk drive (HDD), a floppy disk drive, flash memory, an optical disc, a magneto-optical disc, magnetic tape, or a Universal Serial Bus (USB) drive or a combination of two or more of these. Storage device 2006 may include removable or non-removable (or fixed) media, where appropriate. Storage device 2006 may be internal or external to computing device 2000. In particular implementations, storage device 2006 is non-volatile, solid-state memory. In other implementations, Storage device 2006 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 2008 allows a user to provide input to, receive output from, and otherwise transfer data to and receive data from computing device 2000. I/O interface 2008 may include a mouse, a keypad or a keyboard, a touch screen, a camera, an optical scanner, network interface, modem, other known I/O devices or a combination of such I/O interfaces. I/O interface 2008 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 2008 is configured to provide graphical data to a display for presentation to a user. The graphical data may be representative of one or more graphical user interfaces and/or any other graphical content as may serve a particular implementation.

Communication interface 2010 can include hardware, software, or both. In any event, communication interface 2010 can provide one or more interfaces for communication (such as, for example, packet-based communication) between computing device 2000 and one or more other computing devices or networks. As an example and not by way of limitation, communication interface 2010 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 2010 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 2010 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 2010 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 2012 may include hardware, software, or both that couples components of computing device 2000 to each other. As an example and not by way of limitation, communication infrastructure 2012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 21 is a schematic diagram illustrating environment 2100 within which one or more implementations of the smart organization system 102 can be implemented. For example, the smart organization system 102 may be part of a content management system 2102 (e.g., the content management system 106). Content management system 2102 may generate, store, manage, receive, and send digital content (such as digital content items). For example, content management system 2102 may send and receive digital content to and from client devices 2106 by way of network 2104. In particular, content management system 2102 can store and manage a collection of digital content. Content management system 2102 can manage the sharing of digital content between computing devices associated with a plurality of users. For instance, content management system 2102 can facilitate a user sharing a digital content with another user of content management system 2102.

In particular, content management system 2102 can manage synchronizing digital content across multiple client devices 2106 associated with one or more users. For example, a user may edit digital content using client device 2106. The content management system 2102 can cause client device 2106 to send the edited digital content to content management system 2102. Content management system 2102 then synchronizes the edited digital content on one or more additional computing devices.

In addition to synchronizing digital content across multiple devices, one or more implementations of content management system 2102 can provide an efficient storage option for users that have large collections of digital content. For example, content management system 2102 can store a collection of digital content on content management system 2102, while the client device 2106 only stores reduced-sized versions of the digital content. A user can navigate and browse the reduced-sized versions (e.g., a thumbnail of a digital image) of the digital content on client device 2106. In particular, one way in which a user can experience digital content is to browse the reduced-sized versions of the digital content on client device 2106.

Another way in which a user can experience digital content is to select a reduced-size version of digital content to request the full- or high-resolution version of digital content from content management system 2102. In particular, upon a user selecting a reduced-sized version of digital content, client device 2106 sends a request to content management system 2102 requesting the digital content associated with the reduced-sized version of the digital content. Content management system 2102 can respond to the request by sending the digital content to client device 2106. Client device 2106, upon receiving the digital content, can then present the digital content to the user. In this way, a user can have access to large collections of digital content while minimizing the amount of resources used on client device 2106.

Client device 2106 may be a desktop computer, a laptop computer, a tablet computer, a personal digital assistant (PDA), an in- or out-of-car navigation system, a handheld device, a smart phone or other cellular or mobile phone, or a mobile gaming device, other mobile device, or other suitable computing devices. Client device 2106 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox Paper for iPhone or iPad, Dropbox Paper for Android, etc.), to access and view content over network 2104.

Network 2104 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 2106 may access content management system 2102.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method comprising:
generating a plurality of dynamic facets indicating content attributes associated with a plurality of content items of a content collection stored for a user account of a content management system, the plurality of dynamic facets being selectable to arrange the plurality of content items into respective subgroupings;
based on receiving an indication of a user interaction selecting a dynamic facet from the plurality of dynamic facets, generating a content item segment card for display by a client device within a smart organization interface by:
determining, from among the plurality of content items, a content item segment relevant to the dynamic facet, wherein the content item segment comprises a portion of a content item; and
generating the content item segment card for the content item segment, the content item segment card indicating a location of the content item segment within the content item; and
providing, for display within the smart organization interface, the content item segment card together with content item cards relevant to the dynamic facet.

2. The method of claim 1, further comprising causing the client device to display, within the smart organization interface, the content item cards as visualizations of digital content within corresponding content items stored in respective network locations.

3. The method of claim 2, wherein causing the client device to display the content item cards comprises presenting a first content item card having a first size within the smart organization interface and a second content item card having a second size within the smart organization interface, wherein the second size is different from the first size.

4. The method of claim 1, further comprising providing the content item segment card for display within the smart organization interface by causing the client device to display a visualization of digital content within the content item segment together with a visualization of the location of the content item segment within the content item.

5. The method of claim 4, wherein causing the client device to display the visualization of the digital content within the content item segment comprises providing, for display, a text portion and a page number where the content item segment exists within the content item.

6. The method of claim 4, wherein providing the content item segment card for display comprises excluding other portions of the content item, apart from the content item segment, that are not related to the dynamic facet from the content item segment card.

7. The method of claim 1, further comprising:
receiving, from the client device, an indication of user interaction selecting the content item segment card within the smart organization interface; and
in response to the user interaction selecting the content item segment card, accessing the content item and providing the content item segment within the content item for display.

8. A system comprising:
at least one processor; and
a non-transitory computer readable medium comprising instructions that, when executed by the at least one processor, cause the system to:
generate, by a dynamic facet generator model, a plurality of dynamic facets indicating content attributes associated with a plurality of content items of a content collection stored for a user account of a content management system, the plurality of dynamic facets being selectable to arrange the plurality of content items into respective subgroupings;
based on receiving an indication of a user interaction selecting a dynamic facet from the plurality of dynamic facets, generate a content item segment card for display by a client device within a smart organization interface by:
determining, from among the plurality of content items, a content item segment relevant to the dynamic facet, wherein the content item segment comprises a portion of a content item; and
generating the content item segment card for the content item segment, the content item segment card indicating a location of the content item segment within the content item; and
provide, for display within the smart organization interface, the content item segment card together with content item cards relevant to the dynamic facet.

9. The system of claim 8, further comprising instructions that, when executed by the at least one processor, cause the system to cause the client device to display, within the smart organization interface, the content item cards as visualizations of digital content within corresponding content items stored in respective network locations.

10. The system of claim 9, further comprising instructions that, when executed by the at least one processor, cause the system to display the content item cards by presenting a first content item card having a first size within the smart organization interface and a second content item card having a second size within the smart organization interface, wherein the second size is different from the first size.

11. The system of claim 8, further comprising instructions that, when executed by the at least one processor, cause the system to provide the content item segment card for display within the smart organization interface by causing the client device to display a visualization of digital content within the content item segment together with a visualization of the location of the content item segment within the content item.

12. The system of claim 11, further comprising instructions that, when executed by the at least one processor, cause the system to display the visualization of the digital content within the content item segment by providing, for display, a text portion and a page number where the content item segment exists within the content item.

13. The system of claim 11, further comprising instructions that, when executed by the at least one processor, cause the system to provide the content item segment card for display by excluding other portions of the content item, apart from the content item segment, that are not related to the dynamic facet from the content item segment card.

14. The system of claim 8, further comprising instructions that, when executed by the at least one processor, cause the system to:
receive, from the client device, an indication of user interaction selecting the content item segment card within the smart organization interface; and
in response to the user interaction selecting the content item segment card, accessing the content item and providing the content item segment within the content item for display.

15. A non-transitory computer readable medium comprising instructions that, when executed by at least one processor, cause the at least one processor to:
generate a plurality of dynamic facets indicating content attributes associated with a plurality of content items of a content collection stored for a user account of a content management system, the plurality of dynamic facets being selectable to arrange the plurality of content items into respective subgroupings;
based on receiving an indication of a user interaction selecting a dynamic facet from the plurality of dynamic facets, generate a content item segment card for display by a client device within a smart organization interface by:
determining, from among the plurality of content items, a content item segment relevant to the dynamic facet, wherein the content item segment comprises a portion of a content item; and
generating the content item segment card for the content item segment, the content item segment card indicating a location of the content item segment within the content item; and
provide the content item segment card for display within the smart organization interface.

16. The non-transitory computer readable medium of claim 15, further comprising instructions that, when executed by the at least one processor, cause the at least one processor to cause the client device to display, within the smart organization interface, content item cards relevant to the dynamic facet as visualizations of digital content within corresponding content items stored in respective network locations.

17. The non-transitory computer readable medium of claim 16, further comprising instructions that, when executed by the at least one processor, cause the at least one processor to cause the client device to display the content item cards by presenting a first content item card having a first size within the smart organization interface and a second content item card having a second size within the smart organization interface, wherein the second size is different from the first size.

18. The non-transitory computer readable medium of claim 15, further comprising instructions that, when executed by the at least one processor, cause the at least one processor to provide the content item segment card for display within the smart organization interface by causing the client device to display a visualization of digital content within the content item segment together with a visualization of the location of the content item segment within the content item.

19. The non-transitory computer readable medium of claim 18, further comprising instructions that, when executed by the at least one processor, cause the at least one processor to cause the client device to display the visualization of the digital content within the content item segment by providing, for display, a text portion and a page number where the content item segment exists within the content item.

20. The non-transitory computer readable medium of claim 18, further comprising instructions that, when executed by the at least one processor, cause the at least one processor to provide the content item segment card for display by excluding other portions of the content item, apart from the content item segment, that are not related to the dynamic facet from the content item segment card.
